(19) United States
(12) Patent Application Publication
(10) Pub. No.: US 2023/0020226 A1
(43) Pub. Date: Jan. 19, 2023

(54) TENSION-ACTIVATED, EXPANDING SHEETS WITH COMPOUND SLITS

(71) Applicant: 3M INNOVATIVE PROPERTIES COMPANY, St. Paul, MN (US)

(72) Inventors: Thomas R. Corrigan, St. Paul, MN (US); Patrick R. Fleming, Lake Elmo, MN (US); Delony L. Langer-Anderson, Hugo, MN (US); Lisa M. Miller, Spring Valley, WI (US); Manoj Nirmal, St. Paul, MN (US)

(21) Appl. No.: 17/785,998

(22) PCT Filed: Dec. 16, 2020
(86) PCT No.: PCT/IB2020/062061

§ 371 Date: Jun. 16, 2022

Related U.S. Application Data
(60) Provisional application No. 62/952,815, filed on Dec. 23, 2019.
(60) Provisional application No. 63/058,084, filed on Jul. 29, 2020.

(51) Int. Cl. B31D 5/00; B65D 81/03; B31D 3/02

(52) U.S. Cl. CPC B31D 5/0065; B65D 81/03; B31D 3/0207

(57) ABSTRACT

The present disclosure relates generally to tension-activated, expanding articles that include compound slit patterns. In some embodiments, these articles are used as cushioning films and/or packaging materials. The present disclosure also relates to methods of making and using these tension-activated, expanding articles.

### TECHNICAL FIELD

The present disclosure relates generally to tension-activated, expanding articles that include compound slit patterns. In some embodiments, these articles are used as cushioning films and/or packaging materials. The present disclosure also relates to methods of making and using these tension-activated, expanding articles.

### BACKGROUND

In 2016, consumers bought more products online than in stores. (Consumers Are Now Doing Most of their Shopping Online, Fortune Magazine, Jun. 8, 2016). Specifically, consumers made 51% of their purchases online and 49% in brick-and-mortar stores. Id. One result of this change in consumer behavior is the growing number of packages mailed and delivered each day. Over 13.4 billion packages are delivered to homes and businesses around the world each year (about 5.2 billion by the United States Postal Service, about 3.3 billion by Fed Ex, and about 4.9 billion by UPS). While delivery of non-package mail is decreasing annually, package delivery is growing at a rate of about 8% annually. This growth has resulted in 25% of the U.S. Postal Service's business being package delivery. (Washington Examiner, “For every Amazon package it delivers, the Postal Service loses $1.46,” Sep. 1, 2017). Amazon ships about 3 million packages a day, and Alibaba ships about 12 million packages a day.

It is not just businesses shipping packages. The growing Maker culture creates opportunities for individuals to ship their handmade products around the world through websites like Etsy™. Further, the increased focus on sustainability causes many consumers to resell used products on sites like eBay™ rather than throwing them into landfills. For example, over 25 million people sell goods on eBay™, and over 171 million people buy these goods.

Individuals and businesses shipping these goods often ship them in shipping containers, typically boxes, including the product to be shipped, cushioning, and air. Boxes have many advantages, including, for example, the box can stand upright, it is lightweight, stored flat, is recyclable, and is relatively low cost. However, boxes come in standard sizes that often do not match the size of the item being shipped, so the user must fill the box with a large amount of filler or cushioning material to try to protect the item being shipped from jostling around in a box that is too large and becoming damaged.

Package cushioning materials protect items during shipment. The effects of vibration and impact shock during shipment and loading/unloading are mitigated by the cushioning materials to reduce the chance of product damage. Cushioning materials are often placed inside the shipping container where they absorb energy by, for example, buckling and deforming, and/or by dampening vibration or transmitting the shock and vibration to the cushioning material rather than to the item being shipped. In other instances, packaging materials are also used for functions other than cushioning, such as to immobilize the item to be shipped in the box and fix it in place. Alternatively, packaging materials are also used to fill a void such as, for example, when a box that is significantly larger than the item to be shipped is used.

Some exemplary packaging materials include plastic Bubble Wrap™, bubble film, cushion wrap, air pillows, shredded paper, crinkle paper, shredded aspen, vermiculite, cradles, and corrugated bubble film. Many of these packaging materials are not recyclable.

One exemplary packaging material is shown in FIGS. 1A and 1B. Film 100 is made of a paper sheet including pattern of a plurality of cuts or slits 110 that is often referred to as a “skip slit pattern,” a type of single slit pattern. When film 100 is tension-activated (pulled along the tension axis (T), which is substantially perpendicular to cuts or slits 110), a plurality of beams 130 are formed. Beams 130 are regions between adjacent coaxial rows of slits. The beams 130 formed by slits 110 collectively experience some degree of upward and downward movement (see, for example, FIGS. 1B and 1C). This upward and downward movement results in the two-dimensional article (a substantially flat sheet) of FIG. 1A becoming the three-dimensional article of FIGS. 1B and 1D when tension-activated. When this film is used as packaging material, the three-dimensional structure provides some degree of cushioning as compared to a two-dimensional, flat structure.

The cut or slit pattern of film 100 is shown in FIG. 1A and is described in U.S. Pat. No. 4,105,724 (Talbot) and U.S. Pat. No. 5,667,871 (Goodrich et al.). The pattern includes a plurality of substantially parallel rows 112 of multiple individual linear slits 110. Each of the individual linear slits 110 in a given row 112 is out of phase with each of the individual linear slits 110 in the directly adjacent and substantially parallel row 112. In the specific construction of FIGS. 1A-1C, the adjacent rows 112 are out of phase by one half of the horizontal spacing. The pattern forms an array of slits 110 and rows 112, and the array has a regular, repeating pattern across the array. Between directly adjacent rows 112 of slits 110 are formed beams 130 of material.

FIG. 2A shows the cut or slit pattern of film 100 of FIGS. 1A-1C rotated 90°. Each linear slit 110 has a length (L) that extends between a first terminal end 114 and a second terminal end 116. Each linear slit 110 also has a midpoint 118 that is halfway between the first and second terminal ends 114,116. Midpoint 118 is shown by a dot on two of the slits 110 of FIG. 2A. The midpoints 118 of parallel and aligned slits 110 substantially align with one another. In other words, the midpoint 118 of an individual linear slit 110 substantially aligns with the midpoint 118 of an individual linear slit 110 on a directly adjacent beam 130 along the tension axis (T). Such slits 110 are not in directly adjacent slit rows 112; instead, they are on alternating rows 112. Further, the midpoint 118 of an individual slit 110 is between the terminal ends 114, 116 of the directly adjacent slits or cuts 110 along the tension axis (T). The distance between the center of two directly adjacent slits 110 in a row 112 of slits 110 is identified as the transverse spacing (H). The thickness of beam 130 or distance between two adjacent rows 112 of adjacent linear slits 110 is identified as the axial spacing (V).

More specifically, in the embodiment of FIG. 2A, midpoint 118A of slit 110A aligns axially with midpoint 118B of slit 110B, meaning that the midpoints 118A, 118B align along an axis extending in the axial direction. Slit 110B is on the beam 130B directly adjacent to beam 130A on which slit 110A lies. Also, midpoint 118A of slit 110A is between terminal end 114C of slit 110C and terminal end 116D of slit 110D. Slits 110C and 110D are directly adjacent to slit 110A axially. FIG. 2A also shows the transverse pitch (H) between transversely adjacent midpoints 118, the axial pitch (V) or beam 130 height, the slit length (L), and the tension axis (T) along which tension can be provided to cause upward and downward movement of beams 130.

FIG. 2B shows the primary tension lines (e.g., the lines approximating the highest tensile stress path) formed when an article including the slit pattern of FIG. 2A is deployed with tension along the tension axis T. FIG. 2B shows in dotted lines the primary tension lines 140, which are where the greatest tensile stress will occur. Tension lines are imaginary paths through the material that carry the greatest load when tension is applied to the material along the tension axis. When tension is applied along tension axis (T), the primary tension lines 140 move more closely into alignment with the applied tension axis, causing the material or sheet into which the pattern has been formed to distort. When single slit patterns are deployed, the activation of tension along the primary tension lines 140 causes substantially all regions of the pattern to experience some tension or compression (tensile stress or compressing stress) and then buckle and bend out of the plane of the original two-dimensional film. In some embodiments, when the film is fully deployed and/or tension is applied to the desired extent, substantially no regions exist in the film that remain parallel to the original plane of the sheet.

### SUMMARY

The inventors of the present disclosure invented novel compound slit patterns. These compound slit patterns can be used to form tension-activated, expanding articles. In some embodiments, the articles can be used for shipping and packaging applications. However, the articles and patterns can also be used for a plethora of other uses or applications. So, the present disclosure is not meant to be limited to shipping or packaging material applications, which are merely one exemplary use or application.

Some embodiments relate to an expanding material, comprising: a material including a plurality of compound slits.

In some embodiments, the material is substantially planar in a pretensioned form but wherein at least portions of the material rotate 90 degrees or greater from the plane of the pretensioned form when tension is applied along the tension axis. In some embodiments, the compound slits include more than two terminal ends, and at least one of the terminal ends is curved. In some embodiments, at least some of the compound slits include at least one of hook, loop, sine-wave, square-wave, triangle-wave, cross-slit, or other similar feature. In some embodiments, the slit pattern extends substantially to one or more of the edges of the material. In some embodiments, the material includes at least one of paper, corrugated paper, woven or nonwoven material, plastic, an elastic material, an inelastic material, polyester, acrylic, polysulfone, thermoset, thermoplastic, biodegradable polymers, and combinations thereof. In some embodiments, the material is paper and the thickness is between about 0.003 inch (0.076 mm) and about 0.010 inch (0.25 mm). In some embodiments, the material is plastic and the thickness is between about 0.005 inch (0.13 mm) and about 0.125 inch (3.2 mm). In some embodiments, the material passes the interlocking test described herein. In some embodiments, the slits are generally perpendicular to the tension axis. In some embodiments, the slits in the plurality of slits are offset from one another in adjacent rows by 75% or less of the transverse length of the slit. In some embodiments, the slits have a slit shape and slit orientation and wherein the slit shape and/or orientation varies within a row of slits. In some embodiments, the slits have a slit shape and slit orientation and wherein the slit shape and/or orientation varies in adjacent rows. In some embodiments, the material has a thickness between about 0.001 inch (0.025 mm) and about 5 inches (127 mm). In some embodiments, the each slit in the plurality of slits has a slit length that is between about 0.25 inch and about 3 inches. In some embodiments, each slit in the plurality of slits has a slit length and the material has a material thickness, and wherein the ratio of slit length to material thickness is between about 50 and about 1000.

Some embodiments relate to a die capable of forming any of the compound patterns described herein.

Some embodiments relate to a packaging material formed of any of the expanding materials described herein.

Some embodiments relate to a method of making any of the expanding materials described herein, comprising: forming the compound slit pattern in the material by at least one of by extrusion, molding, laser cutting, water jetting, machining, stereolithography or other 3D printing techniques, laser ablation, photolithography, chemical etching, rotary die cutting, stamping, other suitable negative or positive processing techniques, or combinations thereof.

Some of the embodiments relate to a method of using any of the expanding materials described herein, comprising: applying tension to the expanding material along a tension axis to cause the material to expand. In some embodiments, the application of tension causes one or more of (1) the slits to form openings and/or (2) the material adjacent to the slits to form undulations. In some embodiments, the tension is applied by hand or with a machine. In some embodiments, applying tension to the expanding material along the tension axis causes the material to change from a two-dimensional structure to a three-dimensional structure.

### BRIEF DESCRIPTION OF DRAWINGS

The disclosure may be more completely understood in consideration of the following detailed description of various embodiments of the disclosure in connection with the accompanying drawings.

FIG. 1A is a top view line drawing of an exemplary single slit pattern.

FIG. 1B is a top view line drawing of the slit pattern used to form the packaging material of FIG. 1A.

FIG. 1C is a magnified view of a portion of the drawing of FIG. 1B.

FIG. 2A is a top view line drawing of the slit pattern used to form the packaging material of FIGS. 1A and 1B rotated 90 degrees.

FIG. 2B shows the primary tension lines of the slit pattern shown in FIG. 2A.

FIG. 3A is a top view schematic drawing of an exemplary compound slit pattern.

FIG. 3B shows the primary tension lines in the compound slit pattern of FIG. 3A when it is exposed to tension.

FIGS. 4A-4C are top view schematic drawings showing the movement of the material into which the slit pattern of FIG. 3A has been formed when the material is exposed to tension.

FIG. 4D is a perspective side view schematic drawing of a portion of the material into which the slit pattern of FIG. 3A has been formed when the material is exposed to tension.

FIG. 4E is a perspective side view schematic drawing of the material into which the slit pattern of FIG. 3A has been formed when the material is exposed to tension.

FIGS. 4F-4I are images showing a material into which the slit pattern of FIG. 3A has been formed when the material is exposed to tension. FIG. 4F is a nearly side view drawing from a photograph; FIG. 4G is a top view drawing from a photograph; FIGS. 4H is a nearly perspective view photograph, and 4I is a top view drawing from a photograph.

FIG. 5A is a top view schematic drawing of an exemplary compound slit pattern.

FIGS. 5B-5D are line drawings created from photographs showing the pattern of FIG. 5A cut into a material and deployed along the tension axis shown from the nearly side view, perspective view, and nearly top view, respectively.

FIG. 6 is a top view schematic drawing of an exemplary compound slit pattern.

FIG. 7 is a top view schematic drawing of an exemplary compound slit pattern.

FIG. 8 is a top view schematic drawing of an exemplary compound slit pattern.

FIG. 9 is a top view schematic drawing of an exemplary compound slit pattern.

FIG. 10A is a top view schematic drawing of an exemplary compound slit pattern.

FIGS. 10B-10E are line drawings created from photographs showing the pattern of FIG. 10A cut into a material and deployed along the tension axis shown from the perspective, nearly side, perspective, nearly top, and top views, respectively.

FIG. 11 is a top view schematic drawing of an exemplary compound slit pattern.

FIG. 12 is a top view schematic drawing of an exemplary compound slit pattern.

FIG. 13 is a top view schematic drawing of an exemplary compound slit pattern.

FIG. 14 is a top view schematic drawing of an exemplary compound slit pattern.

FIG. 15 is a top view schematic drawing of an exemplary compound slit pattern.

FIG. 16 is a top view schematic drawing of an exemplary compound slit pattern.

FIG. 17A is a top view schematic drawing of an exemplary compound slit pattern.

FIGS. 17B-17D are line drawings from photographs showing the pattern of FIG. 17A cut into a material and deployed along the tension axis shown from the nearly top, top, and nearly side view, respectively.

FIG. 18A is a top view schematic drawing of an exemplary compound slit pattern.

FIGS. 18B-18C are line drawings from photographs and FIGS. 18D-18E are photographs showing the pattern of FIG. 18A cut into a material and deployed along the tension axis shown from the perspective, a view approximately 45 degrees from transverse aligned with the tension axis, nearly top, and nearly side views, respectively.

FIG. 19 is a top view schematic drawing of an exemplary compound slit pattern.

FIG. 20 is a top view schematic drawing of an exemplary compound slit pattern.

FIGS. 21A and 21B are top and three-quarter, respectively, view schematic drawings of an exemplary compound slit pattern.

FIGS. 21C-21E are a three-quarter, front, side, and top-down views, respectively, a portion of a sheet into which the slit pattern of FIG. 21A-B has been formed when the material is exposed to tension.

FIG. 22 is an example system for making materials consistent with the technology disclosed herein.

### DETAILED DESCRIPTION

Various embodiments of the present disclosure relate to compound slit patterns and to articles including compound slit patterns. A “slit” is defined herein as a narrow cut through the article forming at least one line, which may be straight or curved, having at least two terminal ends. Slits described herein are discrete, meaning that individuals slits do not intersect other slits. A slit is generally not a cut-out, where a “cut-out” is defined as a surface area of the sheet that is removed from the sheet when a slit intersects itself. However, in practice, many forming techniques result in the removal of some surface area of the sheet that is not considered a “cut-out” for the purposes of the present application. In particular, many cutting technologies produce a “kerf”, or a cut having some physical width. For example, a laser cutter will ablate some surface area of the sheet to create the slit, a router will cut away some surface area of the material to create the slit, and even crush cutting creates some deformation on the edges of the material that forms a physical gap across the surface area of the material. Furthermore, molding techniques require material between opposing faces of the slit, creating a gap or kerf at the slit. In various embodiments, the gap or kerf of the slit will be less than or equal to the thickness of the material. For example, a slit pattern cut into paper that is 0.007″ thick might have slits with a gap that is approximately 0.007″ or less. However, it is understood that the width of the slit could be increased to a factor that is many times larger than the thickness of the material and be consistent with the technology disclosed herein.

As used herein, the term “single slit pattern” refers to a pattern of individual slits that form individual rows each extending across the sheet transversely, where the rows form a repeating pattern of individual rows along the axial length of the sheet, and the pattern of slits in each row is different than the pattern of slits in the directly adjacent rows. For example, the slits in one row may be axially offset or out of phase with the slits in the directly adjacent rows.

The term “multi-slit pattern” is defined herein as a pattern of individual slits that form a first set of adjacent rows across the transverse direction y of the sheet, where the individual slits within the first set of adjacent rows are aligned in the transverse direction y. In a multi-slit pattern, the first set of adjacent rows form a repeating pattern with at least a second row along the axial length of the sheet, where the slits in the first set of adjacent identical rows are offset from the slits in the second row in the transverse direction y. The term “multi-slit pattern” includes double slit patterns, triple slit patterns, quadruple slit patterns, etc.

As used herein, the term “compound slit” refers to a slit with more than two terminal ends, which is distinguished from a “simple slit,” which is defined herein as a slit with exactly two terminal ends. Compound slits have at least two slit segments with at least one segment intersection. As such, a “compound slit pattern” is a pattern including a plurality of individual slits at least some of which are compound slits. In some embodiments, the pattern includes a plurality of rows of slits that are phase offset from one another. In some embodiments, the slits are substantially perpendicular to the tension axis (T).

Compound slit patterns can be configured to create significantly more out of plane rotation than single slit patterns when exposed to tension along a tension axis. This out of plane rotation of the material has great value for many applications. For example, the rotated areas create out of plane material that can interlock with other areas of out of plane material when portions of the material are placed adjacent to one another or wrapped together. As such, compound slit patterns inherently interlock and/or include interlocking features. Once tension-activated, these features and patterns interlock and hold the material substantially in place.

Whether a material is interlocking can be determined by the following test method. A sample measuring 36-inches (0.91 m) long and 7.5-inches (19 cm) wide was obtained. The sample was fully deployed without tearing, and was then placed directly adjacent to a smooth PVC pipe (for example, a one having an outer diameter (OD) of 3.15 inches (8 cm) and a length of 23 inches (58.4 cm)), ensuring that the sample remained fully deployed during rolling. The sample was wrapped over the pipe ensuring that each successive layer was placed directly over the previous layer and that the sample was placed at the center (along the length) of the pipe. The same will provide a minimum of two complete wraps around the pipe. When all the sample was wrapped around the pipe, the sample was released and whether the sample unfolded/unwrapped was observed. If the sample did not unfold/unwrap after a 1-minute wait, the sample was slid off the pipe onto a smooth surface such as a table top. The sample was then lifted by the trailing edge to see if it unrolled/unwrapped or held its shape.

If the sample opened/unwrapped within a minute of being released, during sliding it off the pipe, or when lifted by the trailing edge, the sample was deemed “not interlocking”. If the sample held its tubular shape during and after sliding it off the pipe and when lifted by the trailing edge, then it was deemed “interlocking.” The test was repeated 10 times for each sample.

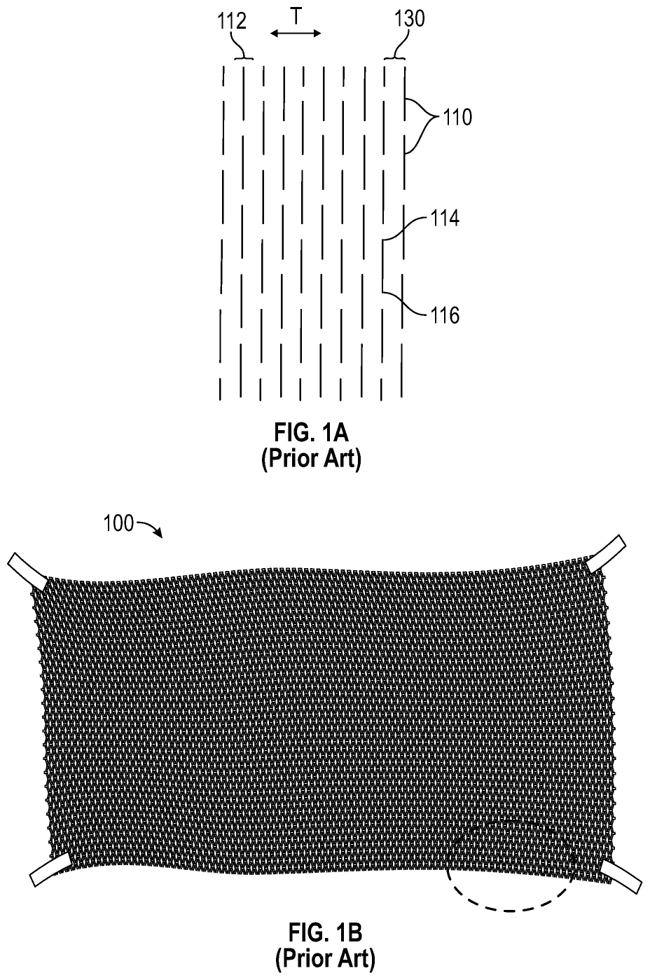

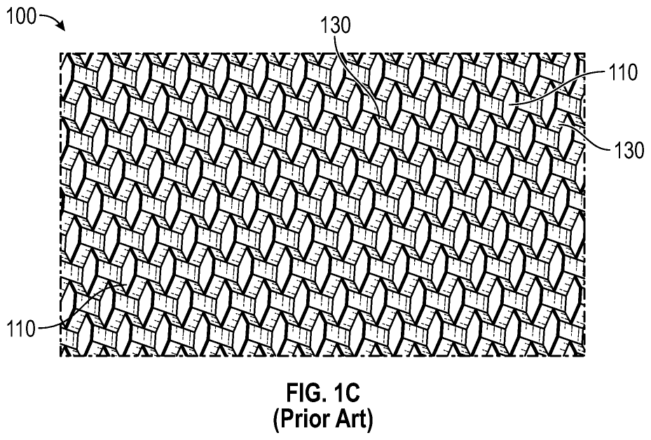

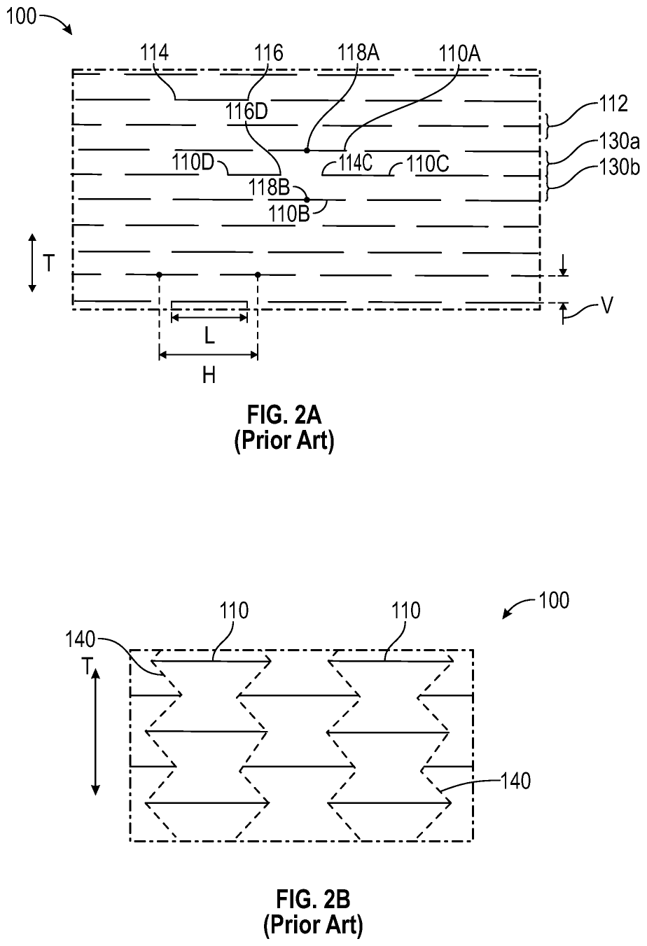

The out of plane rotations also create structures that are very rigid, so they can resist significant forces. The structures can absorb energy in a spring-like fashion without significant plastic deformation and can also buckle and absorb energy by plastically deforming. When compound slit patterns are cut into a two-dimensional article (such as, for example, paper) and tension is applied to the article along the tension axis (T), portions of the two-dimensional article rotate and move into the z-axis (the axis perpendicular to the original plane of the two dimensional article), resulting in the formation of a three-dimensional article. In some embodiments, the slit shapes described herein enable unique out-of-plane motion of the materials or articles as compared to the prior art slits shapes and/or orientations of FIGS. 1A-2B. In some embodiments, the materials into which the compound slit patterns are formed are substantially non-extensible. In some embodiments, the compound slit patterns continue through and are truncated by at least one edge of the material without stopping or changing. The resulting materials and/or articles offer a wide variety of advantages.

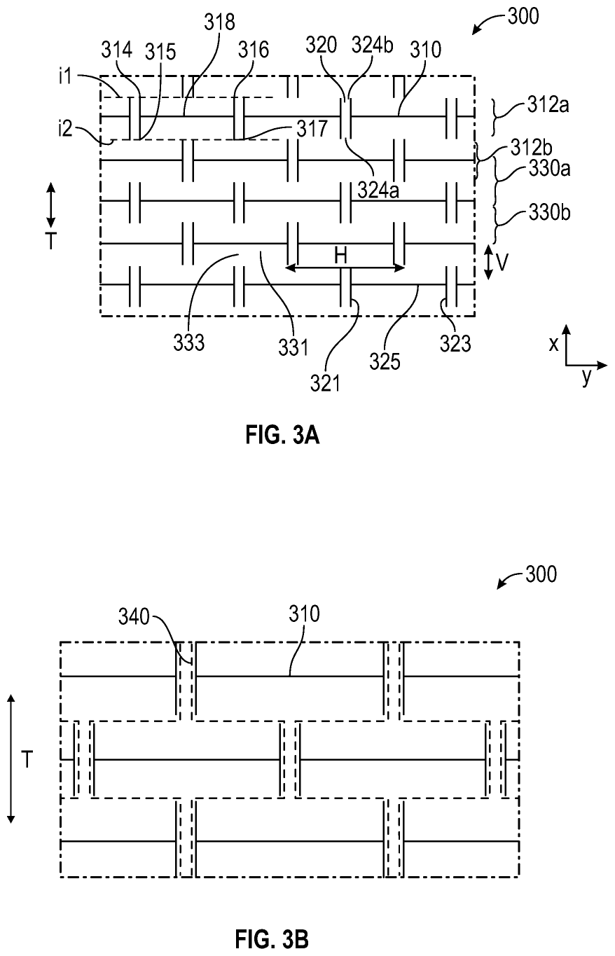

FIG. 3A is a top view schematic drawing of an exemplary compound slit pattern 300. Compound slit patterns can be consistent with single-slit patterns or multi-slit patterns. In this example, the pattern 300 includes a plurality of slits 310 in rows of slits 312. Each slit 310 includes a first axial portion 321, a second axial portion 323 that is spaced from and generally parallel to first axial portion 321, and a generally transverse portion 325 that connects first and second axial portions 321, 323. Each slit 310 includes four terminal ends: a first terminal end 314, a second terminal end 315, a third terminal end 316, and a fourth terminal end 317. Each slit 310 has a midpoint 318.

The first terminal end 314 and the second terminal end 315 are opposite terminal ends of a first axial portion 321 of the slit 310. The third terminal end 316 and the fourth terminal end 317 are opposite terminal ends of second axial portion 323 of the slit 310. The first terminal end 314 is aligned with the third terminal end 316 along an axis in the axial direction x (which is parallel to the first axial portion 321 in the current example) and the third terminal end 316 is aligned with the fourth terminal 317 end along an axis in the axial direction (which is parallel to the second axial portion 323 in the current example). The first terminal end 314 is aligned with the third terminal end 316 along an axis i1 in the transverse direction y and the second terminal end 315 is aligned with the fourth terminal 317 end along an axis i2 in the traverse direction. The space between directly adjacent slits 310 in a row 312a, 312b can be referred to an axial beam 320. When exposed to tension, the axial beam 320 between adjacent slits 310 in a row 312a, 312b becomes a non-rotating beam 320 (visible in FIGS. 3C-3E and 3G). The space bounded by the generally transverse portions 325 subtracting the non-rotating beams 320 defines a folding wall regions 330a, 330b.

The folding wall regions 330a, 330b can be further described as having two generally rectangular regions 331 and 333, where rectangular region 331 is bound by (1) directly adjacent generally transverse portions 325 of slits 310 which are perpendicular to the tension axis and (2) adjacent axial portions 321 and 323 on directly adjacent, opposing slits 310. Axial beams 320 are between adjacent slits 310 in a single row 312a, 312b, more specifically, between the adjacent axial portions 321 and 323. Directly adjacent the beam 320 is a region 333 which is the remaining material in the folding wall region 330a, 330b bounded in the axial direction by the beam 320 and the generally transverse portion 325 and bounded in the transverse direction by the two generally rectangular regions 331, more specifically by the axial extensions of the adjacent axial portions 321 and 323. Directly adjacent rows of slits 310 are phase offset from one another.

In the embodiment of FIG. 3A, the tension axis T is substantially parallel to the axial direction x and substantially perpendicular to the transverse direction y. The tension axis T is generally perpendicular to the direction of the rows 312a, 312b of slits 310. “Generally perpendicular” is defined herein as encompassing angles within a 5-degree margin of error or within a 3-degree margin of error. The tension axis T is an axis along which tension can be provided to deploy the material into which the pattern 300 has been formed, which creates the rotation and upward and downward movement of portions of the material.

In the current example, unlike other examples, there are no transverse beams extending across the width of the sheet of material in the transverse direction y. Rather, in the current example, there are folding wall regions 330a, 330b defined across the transverse width of the material 300 that alternate along the axial length of the sheet of material 300. Similar to some other examples, in the current example the pattern of slits in the sheet of material defines a first row 312a and a second row 312b that alternate along the axial length of the sheet of material 300. The plurality of slits 310 in the sheet of material define columns of beams and rows of beams in which each of the axial beams 320 extend from a first folding wall region 330a to an adjacent second folding wall region 330b. Furthermore, each of the axial beams 320 define two termini 324a, 324b corresponding to the terminal ends of adjacent slits in a row.

FIG. 3B shows the primary tension lines 340 (e.g., the lines approximating the highest tensile stress path) formed when an article including the slit pattern of FIG. 3A is deployed with tension along the tension axis T. FIG. 3B shows in dotted lines the primary tension lines 340, which are where the greatest tensile stress will occur. Tension lines are imaginary paths through the material that carry the greatest load when tension is applied to the material along the tension axis. When tension is applied along tension axis (T), the primary tension lines 340 move more closely into alignment with the applied tension axis, causing the sheet to distort. Tension lines 340 are focused in the axial beams 320 between adjacent slits in the same row. When exposed to tension, these beams 320 become non-rotating beams 320. In the embodiment of FIG. 3A, these non-rotating beams 320 are generally parallel to the tension axis. In the embodiment of FIG. 3A, these non-rotating beams 320 are generally axial. When tension is applied along the tension axis T (which in this embodiment is an axis nominally parallel to the non-rotating beams 320), then the tension (or the highest concentration of stress caused by that tension) exists on all the non-rotating beams 320 somewhat uniformly, but across sections of the folding wall region 330a, 330b as shown by the dotted lines.

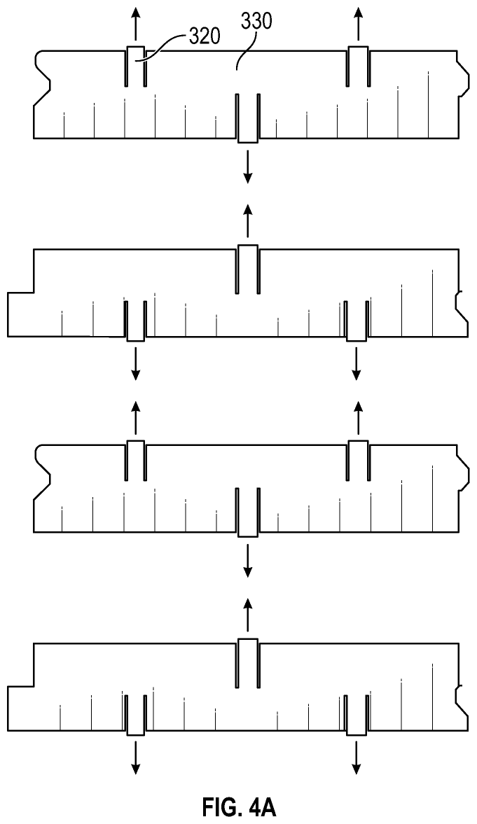

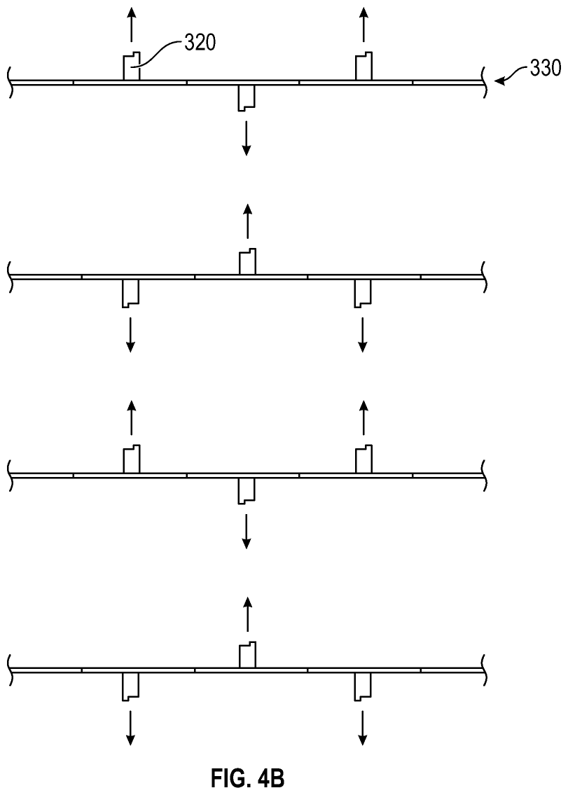

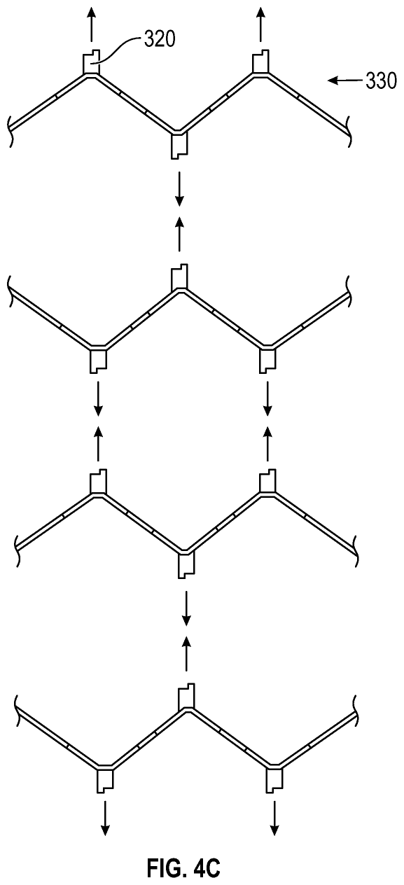

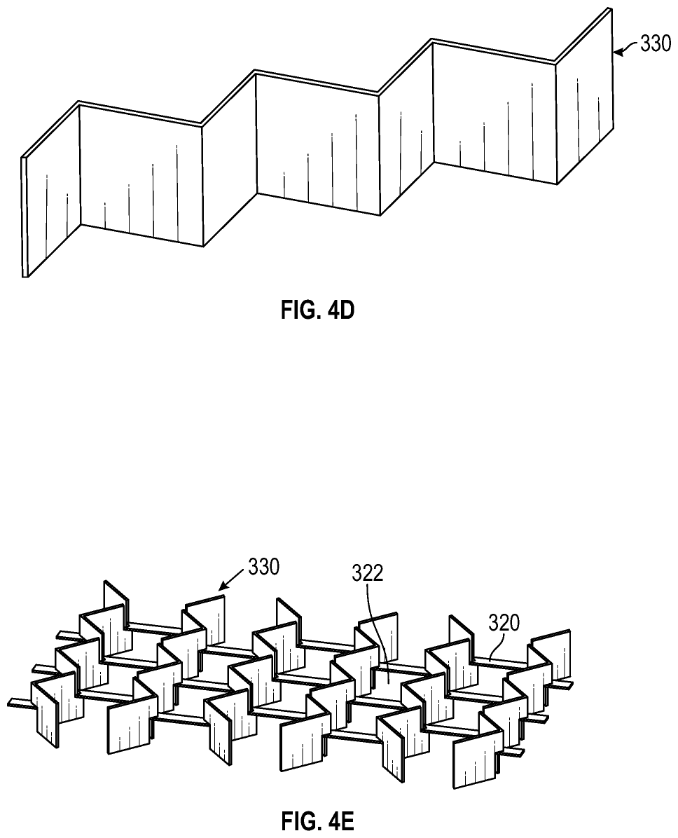

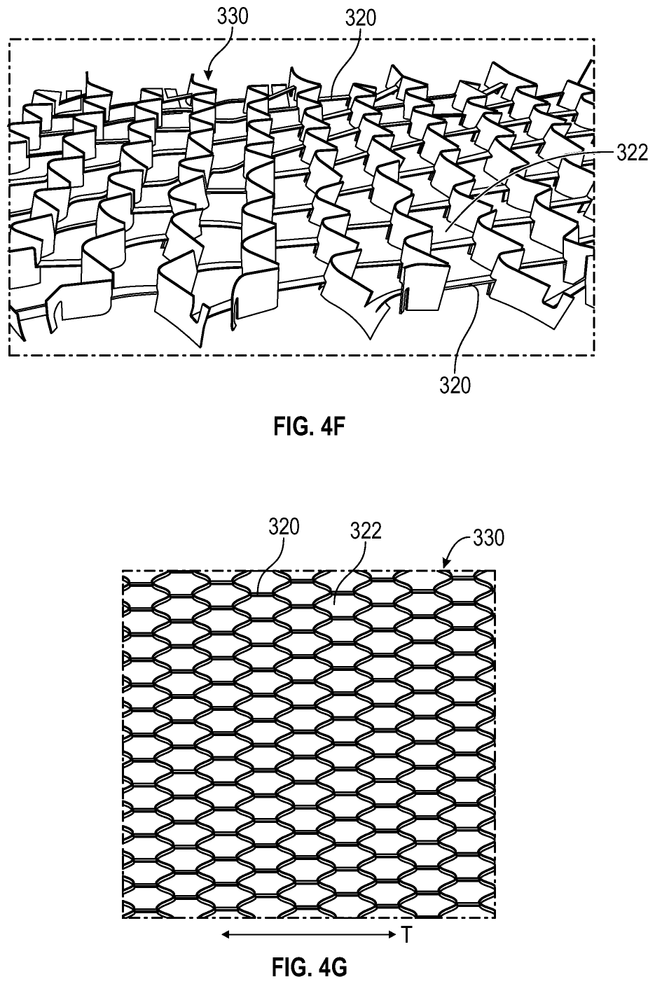

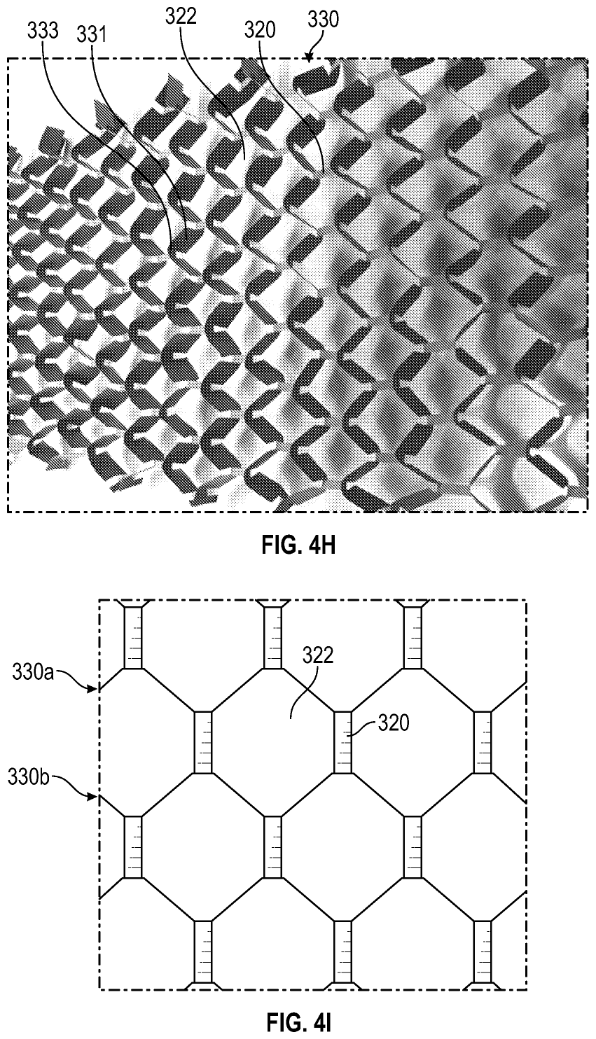

FIGS. 4A-4E are top view schematic drawings showing how a material including the slit pattern of FIG. 3A moves in space when tension is applied along the tension axis T. When compound slit patterns are deployed, the activation of tension along the primary tension lines 340 causes substantially all regions of the pattern to experience some tension or compression (tensile stress or compressing stress) and some of the regions rotate and/or and bend out of the plane of the original two-dimensional film. The tension running through the folding wall region 330 causes the beams to rotate and fold at the same time to move the non-rotating beams 320 closer together to become more aligned with the tension axis T. In FIG. 4A, the non-rotating beams 320 are represented as being broken and connected with force vectors (arrows). This helps visualize the interaction of forces in different regions to clarify the motion of the material. Because the material 300 experiencing the forces is relatively thin, folding wall region 330 will rotate out of plane and fold at the base of the non-rotating beams 320 in response to the application of tension forces. Specifically, FIG. 4A shows non-rotating beams 320 with force vectors acting on the folding wall region 330. This action causes the material 300 to move into the position shown schematically in FIG. 4B, in which the folding wall region 330a, 330b have rotated as a consequence of the force vectors shown in FIG. 4A. As shown in FIG. 4C, the folding wall regions 330 also fold or bend in response to the force vectors shown in FIGS. 4A, 4B, 4C. The degree of fold or bend will vary depending on many factors including, for example, the stiffness or modulus of the material, the magnitude of the tension forces, the dimensions and scale of the elements, the width of non-rotating beams, the span between non-rotating beams, etc.

FIG. 4B is a top view schematic drawing of folding wall region 330 showing only the rotation from a top view perspective in FIG. 4A. FIG. 4C is a schematic drawing showing a top view of the rotating beams that are both rotated and bent when fully tensioned and deployed. From a top view, folding wall regions 330, once rotated, form accordion folded vertical walls that can resist significant compressive force in the Z-axis (orthogonal to the x-y plane). The energy it takes to buckle the folded walls is the energy that can be absorbed by the structure to prevent damage to an object that it is wrapped around. Non-rotating beams 320 connect the folding wall regions 330. The compound slit pattern of FIG. 3A results in the non-rotating beams 320 being staggered, which further contributes to the strength of the material when deployed. The motion of the non-rotating beams 320 and folding wall regions 330a, 330b produces open regions 322, which are visible in FIGS. 4E-4I.

Returning to FIG. 3A, the generally rectangular region 333 has a width, or transverse dimension, that is equal to the width, or transverse dimension, of the non-rotating beam 320. In some embodiments, it is preferred to have this width be small relative to the width, or transverse dimension, of the rectangular region 331. When the transverse width of the rectangular region 333 is small relative to the transverse width of the rectangular region 331, then the rectangular region 333 will substantially crease when deployed and not be clearly independently distinguishable from the remainder of the folding wall regions 330a, 330b as approximated by the drawing of FIG. 4D, and as is visible in FIG. 4G. In particular, in the facing view (top or bottom) of the material of FIG. 4G the shape of the openings 322 appear to be generally hexagonal, as compared to the model view in FIG. 4I where it is more clearly visible in the facing view that the shape of the openings 322 are octagonal. If the rectangular region 333 is wide enough, then another flat vertical section will exist at the folds of the rotating/folding beam shown in FIG. 4I. Visually, this means the openings 322 will resemble octagons rather than hexagons.

FIGS. 4F-4I are photographs and drawings from photographs showing the compound slit pattern of FIG. 3A formed or cut into a paper sheet and then exposed to tension along tension axis T. These figures visually show how the principles described above operate on the material. FIG. 4F is a nearly side perspective view drawing from a photograph; FIG. 4G is a nearly top view drawing from a photograph; FIGS. 4H is a perspective view photograph, and 4I is a top view drawing from a photograph.

In some embodiments, it may be preferred to have the height and width of the bent wall sections, or the rectangular region 331, be nominally equal to create square sections in the folded wall. Without being bound by theory, for a given cross sectional area, a square plate will have the largest buckling resistance.

In some embodiments, the sharp folds in the folded walls as well as the interface between the walls and the non-rotating beams tends to create high enough stress (without ripping) to plastically deform (or crease) the material into which the slit pattern has been formed. As a result, once deployed, the structure tends to stay in the deployed (honeycomb) shape with very little tension, making it easier to wrap around objects in many cases.

Embodiments like the specific implementation of FIGS. 3A-4I have unique benefits. For example, FIGS. 3A-4I exemplify one set of embodiments in which portions of the material rotate to the z-axis (substantially 90° or orthogonal to the original plane of material 300 in its pretensioned state) when deployed or tension-activated. Additionally, some of these embodiments can withstand exposure to greater loads applied in the normal axis relative to other patterned structures without being crushed. This means that they can provide increased or enhanced protection for things like packages being shipped and other applications. Some of these benefits are a result of the increased strength of the folded wall geometry. The folded wall, or accordion shaped wall, or rotating/folding wall has a large area moment of inertia (also called moment of area or second moment of inertia) in the deployed article (deployed via the application of tension or force) where the area moment of inertia is in the plane of the original sheet and the relative bending axis is perpendicular to the tension axis and parallel to the axis of the rows. The area moment of inertia is increased relative to a straight vertical wall without folds.

When the tension-activated material 300 is wrapped around an article or placed directly adjacent to itself, the rotated/folded wall regions 330 interlock with one another and/or opening portions 322, to create an interlocking structure. Interlocking can be measured as stated in the interlocking test articulated above.

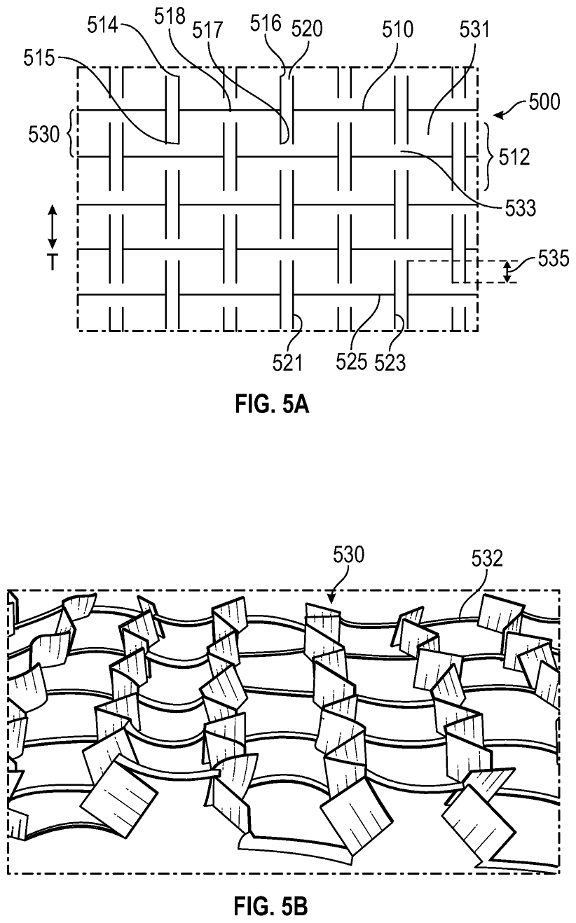

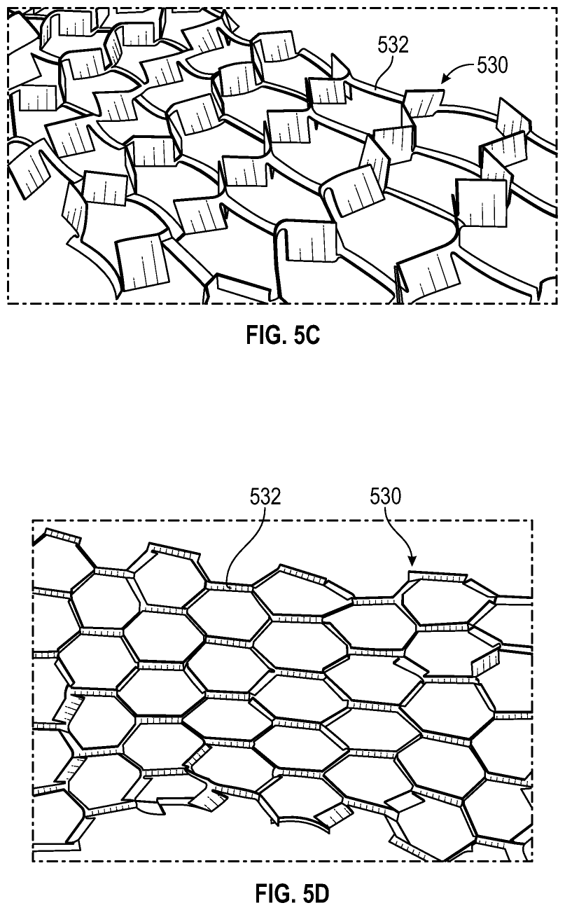

FIG. 5A is a top view schematic drawing of another exemplary compound slit pattern that is substantially the same as the compound slit pattern of FIG. 3A except that the slits overlap one another by an overlap distance 535 in the rotating beam 530 areas. Specifically, the pattern 500 includes a plurality of slits 510 in rows of slits 512. Each slit 510 includes a first axial portion 521, a second axial portion 523 that is spaced from and generally parallel to first axial portion 521, and a generally transverse portion 525 that connects first and second axial portions 521, 523. Each slit 510 includes four terminal ends 514, 515, 516, and 517 and a midpoint 518. First terminal ends 514, 515 are the terminal ends of first axial portion 521. Terminal ends 516, 517 are the terminal ends of second axial portion 523. The space between directly adjacent slits 510 in a row 512 is material forming an axial beam 520 between adjacent slits 510 in a row 512. When exposed to tension, the axial beam 520 between adjacent slits 510 in a row 512 becomes a non-rotating beam 532 (shown in FIGS. 5B-5D). The space bounded by the generally transverse portions 525 subtracting the non-rotating beams 532 comprises a rotating/folding wall 530. The rotating/folding walls 530 can be further described as having two generally rectangular regions 531 and 533, where rectangular region 531 is bound by (1) directly adjacent generally transverse portions 525 of slits 510 which are perpendicular to the tension axis and (2) adjacent axial portions 521 and 523 on directly adjacent, opposing slits 510. Axial beam 520 is present between adjacent slits 510 in a single row 512, more specifically, between the adjacent axial portions 521 and 523. Directly adjacent the axial beam 520 is a region 533 which is the remaining material in the rotating/folding wall 530 bounded in the axial axis by the axial beam 520 and the generally transverse portion 525 and bounded in the transverse axis by the two generally rectangular regions 531, more specifically by the axial extensions of the adjacent axial portions 521 and 523. Directly adjacent rows of slits 510 are phase offset from one another.

In the embodiment of FIG. 5A, the tension axis (T) is substantially parallel to the axial direction and substantially perpendicular to the transverse direction and to the direction of the rows 512 of slits 510. The tension axis (T) is an axis along which tension can be provided to deploy the material into which the pattern 500 has been formed, which creates the rotation and upward and downward movement of portions of the material.

FIGS. 5B-5D are drawings created from photographs showing the compound slit pattern of FIG. 5A formed or cut into a material and then exposed to tension along tension axis T. The material deploys substantially as described above with respect to FIGS. 3A-4I. The existence of an overlap distance 535 contributes to at least two improvements to the deployed material: 1) it allows the rotating/folding wall 530 to rotate more than 90 degrees from the plane of the pretensioned material 500, and 2) it increases the plastic deformation at the connection of the non-rotating beams 532 and the rotating/folding walls 530, allowing the deployed material to stay more fully deployed when external tension forces are removed.

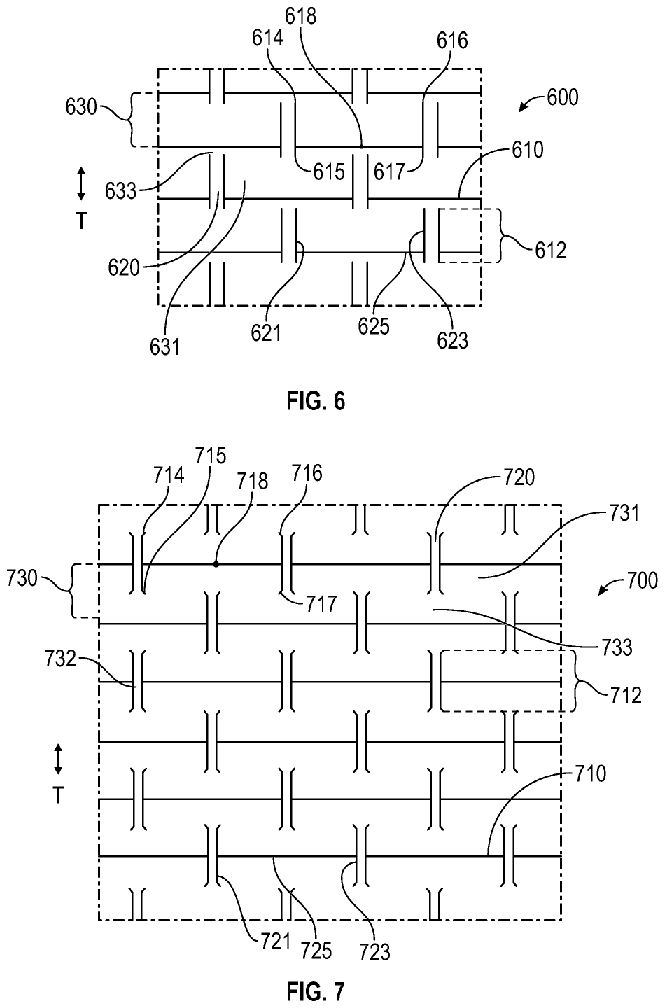

FIG. 6. is a top view schematic drawing of another exemplary compound slit pattern that is substantially the same as the compound slit pattern of FIG. 3A except that it shows an exemplary variation in the axial symmetry of the non-rotating beam. More specifically, the generally transverse portion 625 is not positioned midway between each of terminal ends 614, 615 and 616, 617, respectively. Instead, the generally transverse portion 625 is positioned much closer to terminal ends 615, 617 than to terminal ends 614, 616.

More specifically, the pattern 600 includes a plurality of slits 610 in rows of slits 612. Each slit 610 includes a first axial portion 621, a second axial portion 623 that is spaced from and generally parallel to first axial portion 621, and a generally transverse portion 625 that connects first and second axial portions 621, 623. Each slit 610 includes four terminal ends 614, 615, 616, and 617 and a midpoint 618. First terminal ends 614, 615 are the terminal ends of first axial portion 621. Terminal ends 616, 617 are the terminal ends of second axial portion 623. The space between directly adjacent slits 610 in a row 612 forms an axial beam 620 between adjacent slits 610 in a row 612. When exposed to tension, the axial beam 620 between adjacent slits 610 in a row 612 becomes a non-rotating beam. The space bounded by the generally transverse portions 625 subtracting the axial beams 620 comprises a rotating/folding wall 630. The rotating/folding walls 630 can be further described as having two generally rectangular regions 631 and 633, where rectangular region 631 is bound by (1) directly adjacent generally transverse portions 625 of slits 610 which are perpendicular to the tension axis and (2) adjacent axial portions 621 and 623 on directly adjacent, opposing slits 610. The axial beam 620 is present between adjacent slits 610 in a single row 612, more specifically, between the adjacent axial portions 621 and 623. Directly adjacent the axial beam 620 is a region 633 which is the remaining material in the rotating/folding wall 630 bounded in the axial axis by the axial beam 620 and the generally transverse portion 625 and bounded in the transverse axis by the two generally rectangular regions 631, more specifically by the axial extensions of the adjacent axial portions 621 and 623. Directly adjacent rows of slits 610 are phase offset from one another.

In the embodiment of FIG. 6A, the tension axis (T) is substantially parallel to the axial direction and substantially perpendicular to the transverse direction and to the direction of the rows 612 of slits 610. The tension axis (T) is an axis along which tension can be provided to deploy the material into which the pattern 600 has been formed, which creates the rotation and upward and downward movement of portions of the material.

The material deploys substantially as described above with respect to FIGS. 3A-4I. The change in symmetry of the non-rotating beam relative to the generally transverse portion 625 causes the non-rotating beams to rotate, since one end will be connected higher on one rotating/folding wall 630 and lower on the adjacent rotating/folding wall 630, while remaining parallel to the transverse axis (or a line perpendicular to the tension axis).

FIG. 7 is a top view schematic drawing of another exemplary compound slit pattern that is substantially the same as the compound slit pattern of FIG. 3A except that it shows curved terminal ends. The curved terminal ends are end regions of the slit forming terminal ends of the slit having a radius of curvature that is distinct from adjacent portions of the slit. The end region can be less than 10% of the total length of the slit, where the length of the slit extends in the transverse direction.

More specifically, the pattern 700 includes a plurality of slits 710 in rows of slits 712. Each slit 710 includes a first axial portion 721, a second axial portion 723 that is spaced from and generally parallel to first axial portion 721, and a generally transverse portion 725 that connects first and second axial portions 721, 723. Each slit 710 includes four terminal ends 714, 715, 716, and 717 and a midpoint 718. Each axial portion 721 and 723 includes a curved portion adjacent the terminal ends. First terminal ends 714, 715 are the terminal ends of first axial portion 721. Terminal ends 716, 717 are the terminal ends of second axial portion 723. The space between directly adjacent slits 710 in a row 712 forms an axial beam 720 between adjacent slits 710 in a row 712. When exposed to tension, the axial beam 720 between adjacent slits 710 in a row 712 becomes a non-rotating beam 732. The space bounded by the generally transverse portions 725 subtracting the non-rotating beams 732 comprises a rotating/folding wall 730. The rotating/folding walls 730 can be further described as having two generally rectangular regions 731 and 733, where rectangular region 731 is bound by (1) directly adjacent generally transverse portions 725 of slits 710 which are perpendicular to the tension axis and (2) adjacent axial portions 721 and 723 on directly adjacent, opposing slits 710. Axial beam 720 is present between adjacent slits 710 in a single row 712, more specifically, between the adjacent axial portions 721 and 723. Directly adjacent the axial beam 720 is a region 733 which is the remaining material in the rotating/folding wall 730 bounded in the axial axis by the axial beam 720 and the generally transverse portion 725 and bounded in the transverse axis by the two generally rectangular regions 731, more specifically by the axial extensions of the terminal ends 714, 715, 716, and 717 adjacent axial portions 721 and 723. Directly adjacent rows of slits 710 are phase offset from one another.

In the embodiment of FIG. 7A, the tension axis (T) is substantially parallel to the axial direction and substantially perpendicular to the transverse direction and to the direction of the rows 712 of slits 710. The tension axis (T) is an axis along which tension can be provided to deploy the material into which the pattern 700 has been formed, which creates the rotation and upward and downward movement of portions of the material.

The material deploys substantially as described above with respect to FIGS. 3A-4I. The addition of the curved terminal ends 714, 715, 716, and 717 onto the axial portions 721 and 723 increases the maximum force that the material can experience before tearing, but it does not significantly change the deployment of the material.

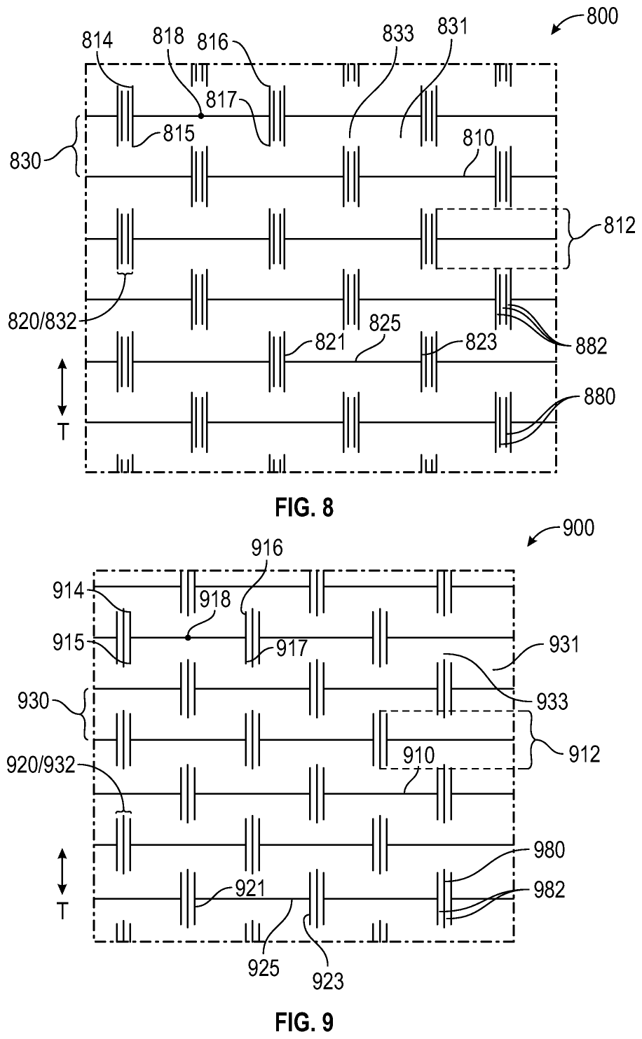

FIG. 8 is a top view schematic drawing of another exemplary compound slit pattern that is substantially the same as the compound slit pattern of FIG. 3A except that it shows an exemplary variation in which there are two multibeam slits 880 formed in the material between adjacent slits 810 in a row 812 the non-rotating beam. A “multibeam slit” is defined as one or more simple slits (meaning the slit has no more than two terminal ends) formed between two adjacent slits in the single slit or multi-slit pattern, where the two adjacent slits are either in the same row or adjacent rows. The multibeam slits 880 create three multibeams 882 when the material into which the pattern is formed is tension-deployed.

More specifically, the pattern 800 includes a plurality of slits 810 in rows of slits 812. Each slit 810 includes a first axial portion 821, a second axial portion 823 that is spaced from and generally parallel to first axial portion 821, and a generally transverse portion 825 that connects first and second axial portions 821, 823. Each slit 810 includes four terminal ends 814, 815, 816, and 817 and a midpoint 818. First terminal ends 814, 815 are the terminal ends of first axial portion 821. Terminal ends 816, 817 are the terminal ends of second axial portion 823. The space between directly adjacent slits 810 in a row 812 forms an axial beam 820 between adjacent slits 810 in a row 812. When exposed to tension, the axial beam 820 between adjacent slits 810 in a row 812 becomes a non-rotating beam 832 that includes three multibeams 882. In this embodiment, two multibeam slits 880 are formed in the axial beam 820 between adjacent slits 810 in row 812. The multibeam slits 880 are slightly shorter in length than the generally axial slits 821, 823 of the directly adjacent slits 810 between which it is positioned. The midpoints of the multibeam slit 880 generally aligns with the midpoint of the generally axial slit portions 821, 823 and with the generally transverse slit portion 825. The multibeam slits 880 create three multibeams 882 when the material into which the pattern is formed is tension-deployed.

The space bounded by the generally transverse portions 825 subtracting the non-rotating beams 832 comprises a rotating/folding wall 830. The rotating/folding walls 830 can be further described as having two generally rectangular regions 831 and 833, where rectangular region 831 is bound by (1) directly adjacent generally transverse portions 825 of slits 810 which are perpendicular to the tension axis and (2) adjacent axial portions 821 and 823 on directly adjacent, opposing slits 810. Axial beam 820 is present between adjacent slits 810 in a single row 812, more specifically, between the adjacent axial portions 821 and 823. Directly adjacent the axial beam 820 is a region 833 which is the remaining material in the rotating/folding wall 830 bounded in the axial axis by the axial beam 820 and the generally transverse portion 825 and bounded in the transverse axis by the two generally rectangular regions 831, more specifically by the axial extensions of the adjacent axial portions 821 and 823. Directly adjacent rows of slits 810 are phase offset from one another.

In the embodiment of FIG. 8, the tension axis (T) is substantially parallel to the axial direction and substantially perpendicular to the transverse direction and to the direction of the rows 812 of slits 810. The tension axis (T) is an axis along which tension can be provided to deploy the material into which the pattern 800 has been formed, which creates the rotation and upward and downward movement of portions of the material.

The material deploys substantially as described above with respect to FIGS. 3A-4I. The three multibeams 882 in the non-rotating beam 832 allows the material to experience larger tension forces without tearing. This is because the multibeams 882 create additional paths and corners to distribute the tension load reducing the peak stress that might initiate a tear.

FIG. 9 is a top view schematic drawing of another exemplary compound slit pattern that is substantially the same as the compound slit pattern of FIG. 8 except that it shows an exemplary variation in which there is one multibeam slit 980 formed in the axial beam 920 between adjacent slits 910 in a row 912 the non-rotating beam. The multibeam slit 980 creates two multibeams 982 when the material into which the pattern is formed is tension-deployed.

More specifically, the pattern 900 includes a plurality of slits 910 in rows of slits 912. Each slit 910 includes a first axial portion 921, a second axial portion 923 that is spaced from and generally parallel to first axial portion 921, and a generally transverse portion 925 that connects first and second axial portions 921, 923. Each slit 910 includes four terminal ends 914, 915, 916, and 917 and a midpoint 918. First terminal ends 914, 915 are the terminal ends of first axial portion 921. Terminal ends 916, 917 are the terminal ends of second axial portion 923. The space between directly adjacent slits 910 in a row 912 forms an axial beam 920 between adjacent slits 910 in a row 912. When exposed to tension, the axial beam 920 between adjacent slits 910 in a row 912 becomes a non-rotating beam 932 that includes two multibeams 982. In this embodiment, a multibeam slit 980 is formed in the axial beam 920 between adjacent slits 910 in row 912. The multibeam slit 980 is slightly longer in length than the generally axial slits 921, 923 of the directly adjacent slits 910 between which it is positioned. The midpoints of the multibeam slit 980 generally aligns with the midpoint of the generally axial slit portions 921, 923 and with the generally transverse slit portion 925. The multibeam slit 980 creates two multibeams 982 when the material into which the pattern is formed is tension-deployed.

The space bounded by the generally transverse portions 925 subtracting the non-rotating beams 932 comprises a rotating/folding wall 930. The rotating/folding walls 930 can be further described as having two generally rectangular regions 931 and 933, where rectangular region 931 is bound by (1) directly adjacent generally transverse portions 925 of slits 910 which are perpendicular to the tension axis and (2) adjacent axial portions 921 and 923 on directly adjacent, opposing slits 910. Axial beam 920 is present between adjacent slits 910 in a single row 912, more specifically, between the adjacent axial portions 921 and 923. Directly adjacent the axial beam 920 is a region 933 which is the remaining material in the rotating/folding wall 930 bounded in the axial axis by the axial beam 920 and the generally transverse portion 925 and bounded in the transverse axis by the two generally rectangular regions 931, more specifically by the axial extensions of the adjacent axial portions 921 and 923. Directly adjacent rows of slits 910 are phase offset from one another.

In the embodiment of FIG. 9, the tension axis (T) is substantially parallel to the axial direction and substantially perpendicular to the transverse direction and to the direction of the rows 912 of slits 910. The tension axis (T) is an axis along which tension can be provided to deploy the material into which the pattern 900 has been formed, which creates the rotation and upward and downward movement of portions of the material.

The material deploys substantially as described above with respect to FIGS. 3A-4I. The two multibeams 982 in the non-rotating beam 932 allows the material to experience larger tension forces without tearing. This is because the multibeams 982 create additional paths and corners to distribute the tension load reducing the peak stress that might initiate a tear.

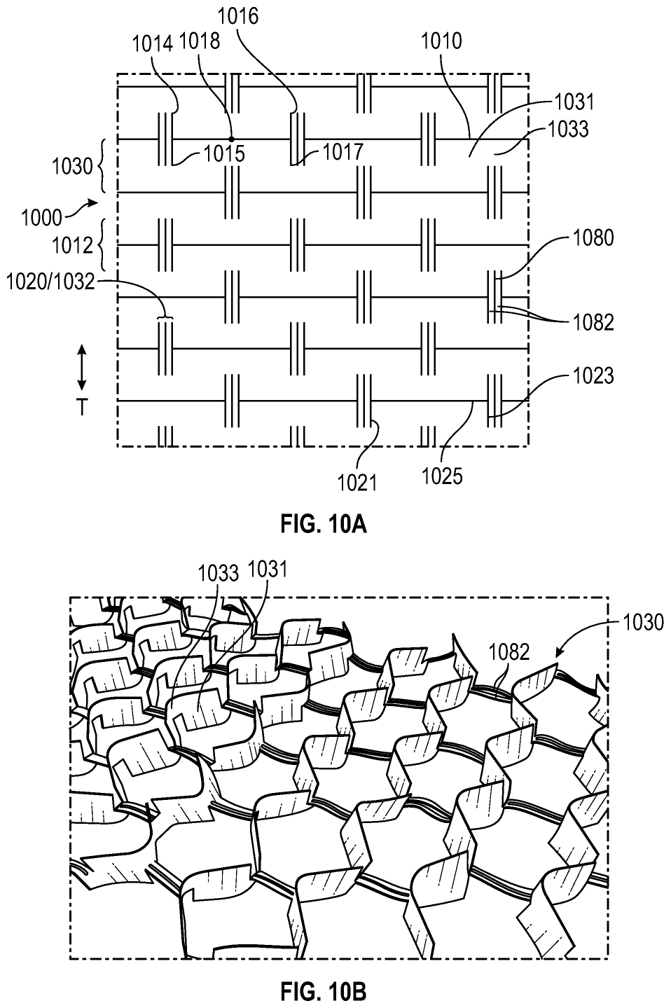

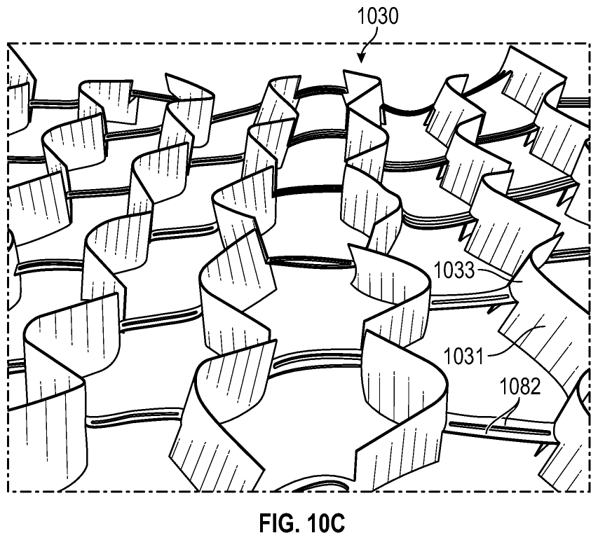

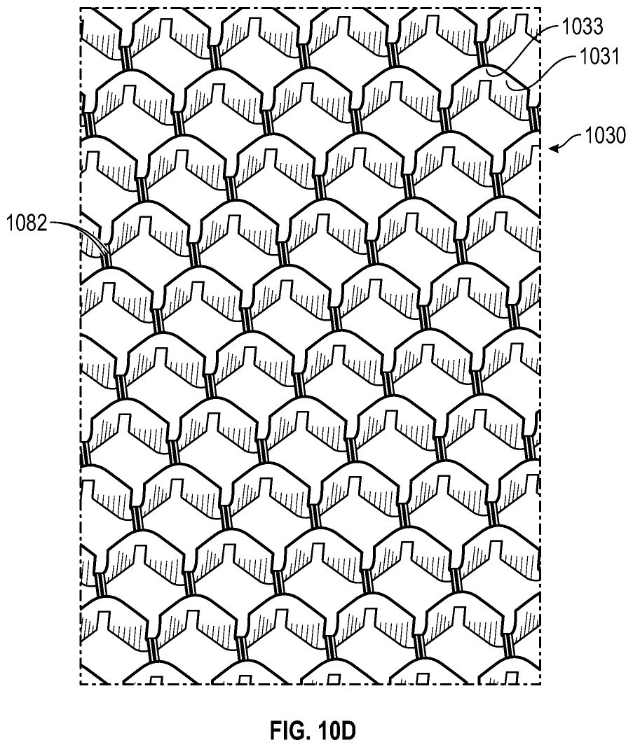

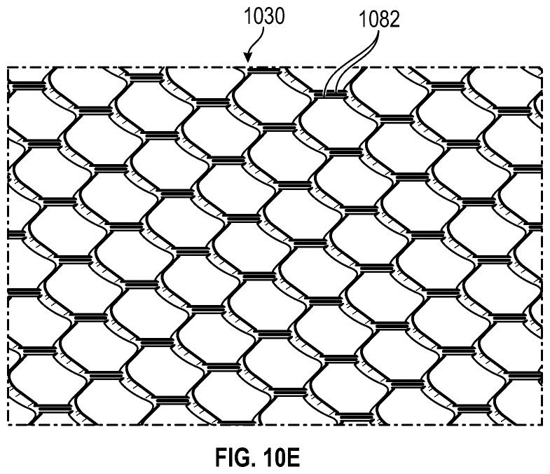

FIG. 10A is a top view schematic drawing of another exemplary compound slit pattern that is substantially the same as the compound slit pattern of FIG. 9 except that the multibeam slit 1080 is the same length as the generally axial slits 1021, 1023.

More specifically, the pattern 1000 includes a plurality of slits 1010 in rows of slits 1012. Each slit 1010 includes a first axial portion 1021, a second axial portion 1023 that is spaced from and generally parallel to first axial portion 1021, and a generally transverse portion 1025 that connects first and second axial portions 1021, 1023. Each slit 1010 includes four terminal ends 1014, 1015, 1016, and 1017 and a midpoint 1018. First terminal ends 1014, 1015 are the terminal ends of first axial portion 1021. Terminal ends 1016, 1017 are the terminal ends of second axial portion 1023. The space between directly adjacent slits 1010 in a row 1012 forms an axial beam 1020 between adjacent slits 1010 in a row 1012. When exposed to tension, the axial beam 1020 between adjacent slits 1010 in a row 1012 becomes a non-rotating beam 1032 that includes two multibeams 1082 (shown in FIGS. 10B-10D). In this embodiment, a multibeam slit 1080 is formed in the axial beam 1020 between adjacent slits 1010 in row 1012. The multibeam slit 1080 approximately the same length as the generally axial slits 1021, 1023 of the directly adjacent slits 1010 between which it is positioned. Also, the midpoint of the multibeam slit 1080 generally aligns with the midpoint of the generally axial slit portions 1021, 1023 and with the generally transverse slit portion 1025. The multibeam slit 1080 creates two multibeams 1082 when the material into which the pattern is formed is tension-deployed.

The space bounded by the generally transverse portions 1025 subtracting the non-rotating beams 1032 comprises a rotating/folding wall 1030. The rotating/folding walls 1030 can be further described as having two generally rectangular regions 1031 and 1033, where rectangular region 1031 is bound by (1) directly adjacent generally transverse portions 1025 of slits 1010 which are perpendicular to the tension axis and (2) adjacent axial portions 1021 and 1023 on directly adjacent, opposing slits 1010. Material 1020 is present between adjacent slits 1010 in a single row 1012, more specifically, between the adjacent axial portions 1021 and 1023. Directly adjacent the axial beam 1020 is a region 1033 which is the remaining material in the rotating/folding wall 1030 bounded in the axial axis by the axial beam 1020 and the generally transverse portion 1025 and bounded in the transverse axis by the two generally rectangular regions 1031, more specifically by the axial extensions of the adjacent axial portions 1021 and 1023. Directly adjacent rows of slits 1010 are phase offset from one another.

In the embodiment of FIG. 10, the tension axis (T) is substantially parallel to the axial direction and substantially perpendicular to the transverse direction and to the direction of the rows 1012 of slits 1010. The tension axis (T) is an axis along which tension can be provided to deploy the material into which the pattern 1000 has been formed, which creates the rotation and upward and downward movement of portions of the material.

FIGS. 10B-10E are drawings from photographs showing the compound slit pattern of FIG. 10A formed or cut into a material and then exposed to tension along tension axis T. The material deploys substantially as described above with respect to FIGS. 3A-4I. The two multibeams 1082 in the non-rotating beam 1032 allows the material to experience larger tension forces without tearing. This is because the multibeams 1082 create additional paths and corners to distribute the tension load reducing the peak stress that might initiate a tear.

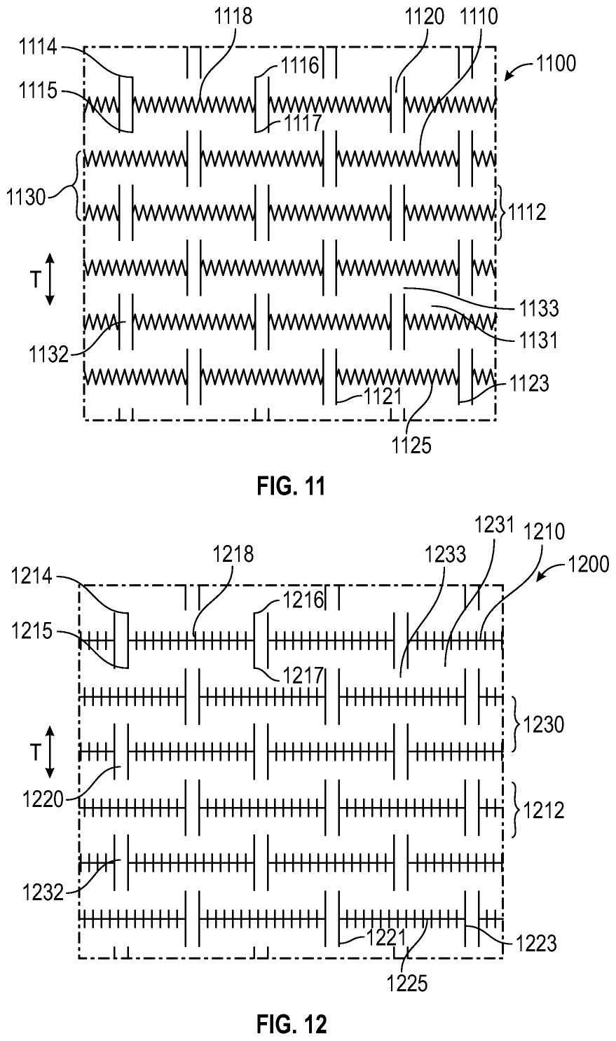

FIGS. 11 are 12 are top view schematic drawings of another exemplary compound slit pattern that is substantially the same as the compound slit pattern of FIG. 3A except that generally transverse portion 1125, 1225 includes interlocking structures or features. These features can increase the interlocking of the material when it is placed adjacent to another layer of the material and/or when it is wrapped around an item. Further, these features may soften the edges of the material. In FIG. 11, the generally transverse portion 1125 has a wavy or v-wave shape. The “v” portions of the wave create the interlocking features. In FIG. 12, the generally transverse portion 1225 has a cross-slit structure. The cross-slit portions create the interlocking features.

In the embodiments of FIGS. 11 and 12, the tension axis (T) is substantially parallel to the axial direction and substantially perpendicular to the transverse direction and to the direction of the rows of slits. The tension axis (T) is an axis along which tension can be provided to deploy the material into which the pattern 1100, 1200 has been formed, which creates the rotation and upward and downward movement of portions of the material.

The material deploys substantially as described above with respect to FIGS. 3A-4I. When multiple layers of the material are in contact, such as when wrapped around an object, then the interlocking features allow the layers to interlock with each other more strongly and/or in different ways.

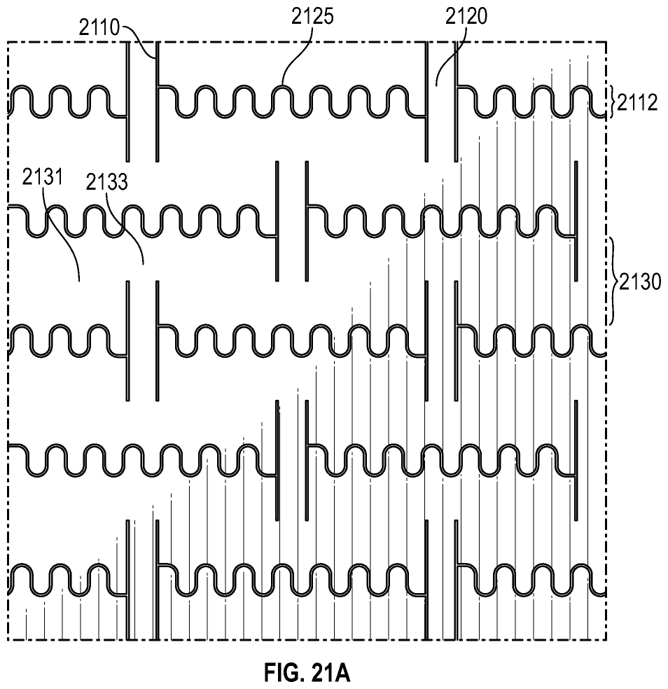

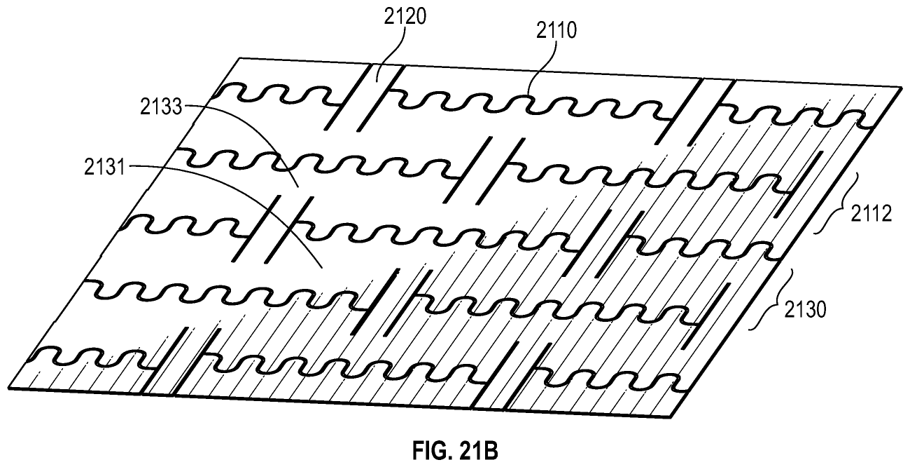

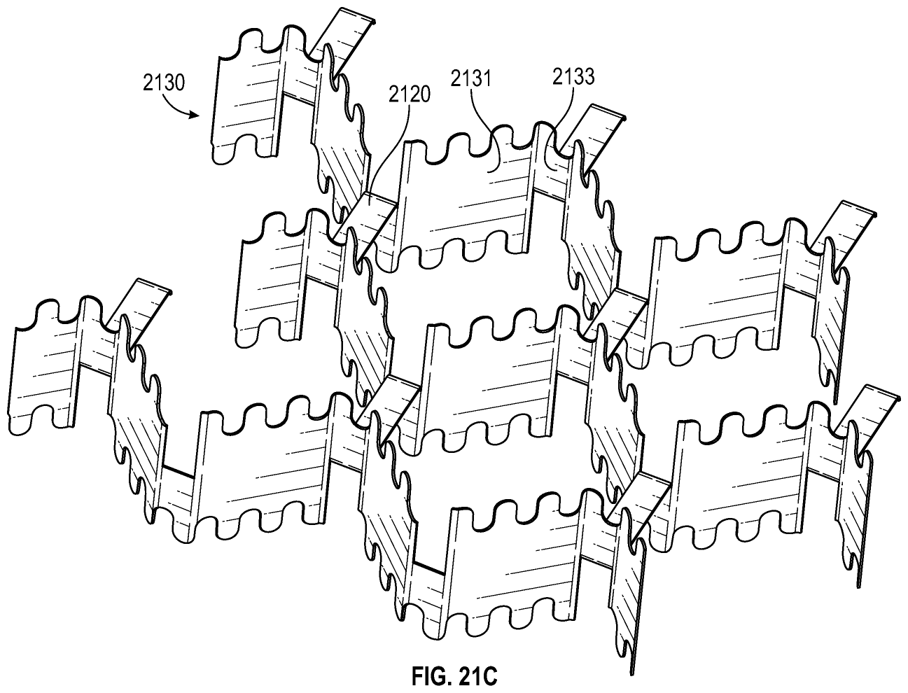

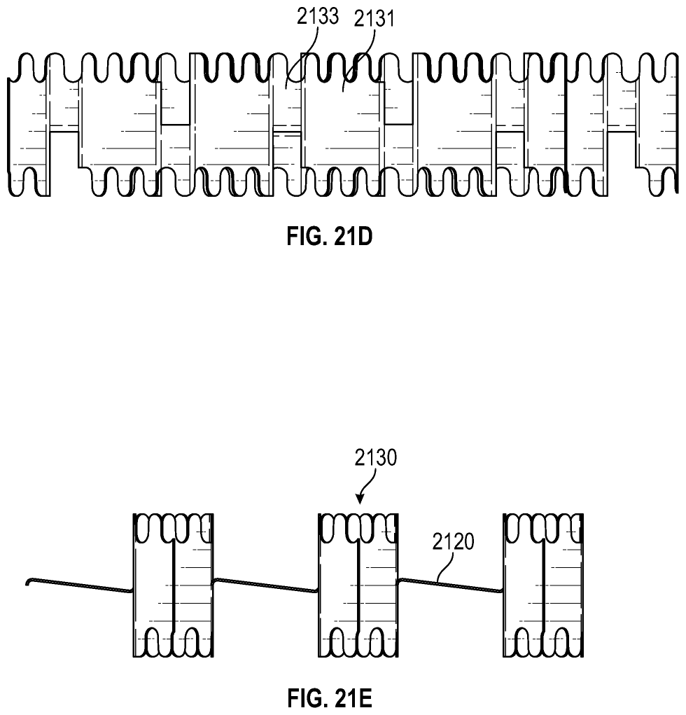

FIGS. 21A-21B depict a compound slit pattern in a sheet of material 2100 similar to the pattern of FIG. 11 except that the interlocking structures or features have a somewhat different shape. The transverse portion 2125 of each of the slits defines a curved line. In particular, the transverse portions 2125 of the slits in a row 2112 generally define an undulating wave or a sine wave that is interrupted by axial beams 2120 between each of the slits 2110. FIGS. 21C-21E show a sheet of material with the compound slit pattern of FIGS. 21A-21B when the material is expanded after being placed under tension in the tension axis.

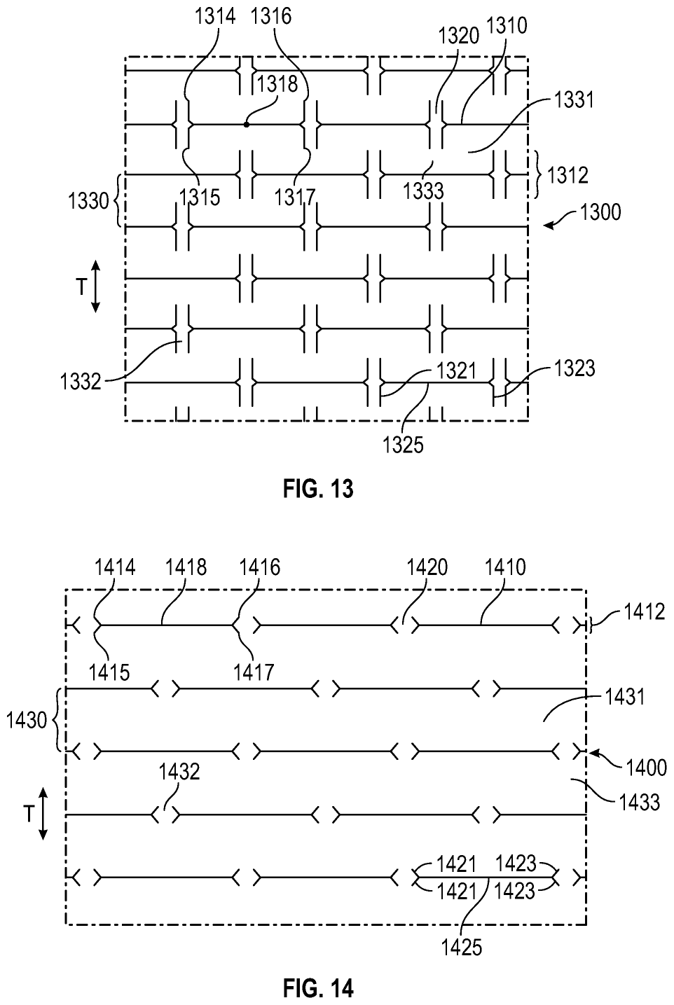

FIG. 13 is a top view schematic drawing of another exemplary compound slit pattern that is substantially the same as the compound slit pattern of FIG. 3A except that the intersections between the generally transverse slit portion 1325 and the two generally axial slit portions 1321, 1323 are rounded or have rounded corners. These features may soften the edges of the material by removing sharp corners that users might encounter during use of the material. In this embodiment, the tension axis (T) is substantially parallel to the axial direction and substantially perpendicular to the transverse direction and to the direction of the rows of slits. The tension axis (T) is an axis along which tension can be provided to deploy the material into which the pattern 1300 has been formed, which creates the rotation and upward and downward movement of portions of the material. The material deploys substantially as described above with respect to FIGS. 3A-4I.

FIG. 14 is a top view schematic drawing of another exemplary compound slit pattern. The pattern 1400 includes a plurality of slits 1410 in rows of slits 1412. Each slit 1410 includes a generally transverse portion 1425 that terminates in four terminal ends 1414, 1415, 1416, and 1417 and has a midpoint 1418. Terminal ends 1414, 1415, 1416, and 1417 each curve slightly away from transverse portion 1425. The space between directly adjacent slits 1410 in a row 1412 forms an axial beams 1420 between adjacent slits 1410 in a row 1412. When exposed to tension, the axial beams 1420 between adjacent slits 1410 in a row 1412 becomes a non-rotating beam 1432.

The space bounded by the generally transverse portions 1425 subtracting the non-rotating beams 1432 comprises a rotating/folding wall 1430. The rotating/folding walls 1430 can be further described as having two generally rectangular regions 1431 and 1433, where rectangular region 1431 is bound by (1) directly adjacent generally transverse portions 1425 of slits 1410 which are perpendicular to the tension axis and (2) adjacent axial portions (which are imaginary axial lines through terminal ends 1414, 1415 and 1416, 1417, respectively) on directly adjacent, opposing slits 1410. Axial beam 1420 is present between adjacent slits 1410 in a single row 1412, more specifically, between the adjacent axial portions 1421 and 1423. Directly adjacent the axial beam 1420 is a region 1433 which is the remaining material in the rotating/folding wall 1430 bounded in the axial axis by the axial beam 1420 and the generally transverse portion 1425 and bounded in the transverse axis by the two generally rectangular regions 1431, more specifically by the axial extensions of the adjacent axial portions 1421 and 1423. Directly adjacent rows of slits 1410 are phase offset from one another.

The tension axis (T) is substantially parallel to the axial direction and substantially perpendicular to the transverse direction and to the direction of the rows 1412 of slits 1410. The tension axis (T) is an axis along which tension can be provided to deploy the material into which the pattern 1400 has been formed, which creates the rotation and upward and downward movement of portions of the material.

The material deploys differently than the FIGS. 3A-4I, because the axial portions 1421 and 1423 do not extend axially far enough to align or overlap. Because they do not align or overlap, the rotating/folding walls 1430 will not be able to rotate 90 degrees relative to the original plane of the pretensioned sheet 1400. Instead, the rotating/folding walls will buckle and rotate slightly. If the axial portions 1421 and 1423 are very short relative to the axial pitch, the material will deploy more similarly to the simple slit pattern of FIG. 1A-C. The curved ends of the axial portions 1421 and 1423 will increase the maximum tension force that the material can experience without ripping. A test method for measuring the maximum tension force is described in U.S. Provisional Patent Application No. 62/953,042, assigned to the present assignee, the entirety of which is incorporated by reference herein. The Maximum Tension Force (e.g., tear force), is the maximum force measured by the load frame as the sample is stretched. This is typically just before the material begins to tear.

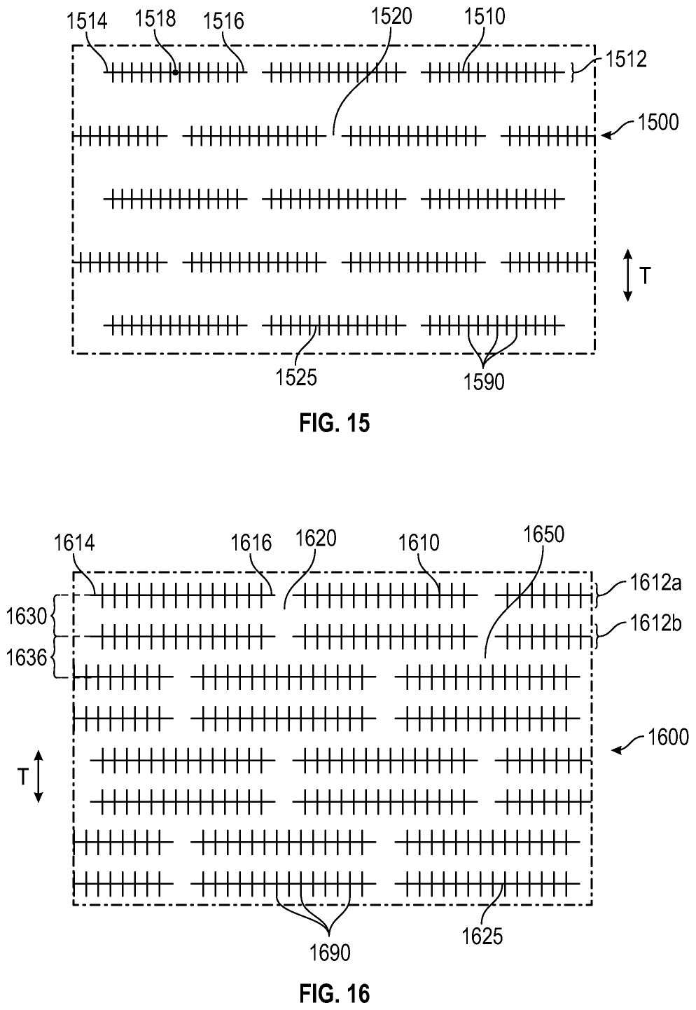

FIG. 15 is a top view schematic drawing of another exemplary compound slit pattern. The pattern 1500 includes a plurality of slits 1510 in rows of slits 1512. Each slit 1510 includes a generally transverse portion 1525 that terminates in two terminal ends 1514, 1516, has a midpoint 1518, and includes a plurality of cross-slits 1590 cut through and intersecting generally transverse portion 1525 and generally parallel to the tension axis T. Each cross-slit 1590 could be interpreted as creating two additional terminal ends. As such, the embodiment of FIG. 15 could be interpreted as having 30 terminal ends (14×2=28 terminal ends from the 14 cross-slits+2 terminal ends on the generally transverse portion 1525). The cross-hatch slits additionally provide enhanced interlocking features. Material 1520 is present between adjacent slits 1510 in a row 1512. Directly adjacent rows of slits 1510 are phase offset from one another.

The tension axis (T) is substantially parallel to the axial direction and substantially perpendicular to the transverse direction and to the direction of the rows 1512 of slits 1510. The tension axis (T) is an axis along which tension can be provided to deploy the material into which the pattern 1500 has been formed, which creates the rotation and upward and downward movement of portions of the material.

The material deploys substantially as described above with respect to FIGS. 1A-1C. When multiple layers of the material are in contact, such as when wrapped around an object, then the cross-slits allow the layers to interlock with each other while straight slits (such as FIG. 1A-C) do not interlock.

FIG. 16 is a top view schematic drawing of another exemplary compound slit pattern that is substantially similar to the compound slit pattern of FIG. 15 except that the slits are double slits. As used herein, the term “double slit pattern” refers to a pattern of a plurality of individual slits. The pattern includes a plurality of rows of slits and the individual slits in a first row are substantially aligned with the individual slits in a directly adjacent, second row. A double slit is comprised of a slit in a first row that is substantially aligned with a slit in a second row. Together, these two substantially aligned slits form a double slit. Double slits in directly adjacent rows (directly adjacent axially) are phase offset from one another. More information about double slit patterns can be found in, for example, U.S. Provisional Patent Application No. 62/952,806, the content of which is incorporated herein in its entirety.

The tension axis (T) is substantially parallel to the axial direction and substantially perpendicular to the transverse direction and to the direction of the rows 1612 of slits 1610. The tension axis (T) is an axis along which tension can be provided to deploy the material into which the pattern 1600 has been formed, which creates the rotation and upward and downward movement of portions of the material.

When material 1600 is tension activated or deployed along tension axis T, portions of material 1600 experience tension and/or compression that causes material 1600 to move out of the original plane of material 1600 in its non-tensioned format. When exposed to tension along the tension axis, terminal ends 1614, 1616 experience compression and are drawn toward one another, causing a flap region 1650 of the material 1600 to move or buckle upward relative to the plane of the material 1600 in its pretensioned state, creating a flap. The flap region 1650 includes a portion of the cross-slits including a portion of the cross-slit terminal ends. Portions of transverse beams 1630 undulate out of the original plane of the material 1600 in its pretensioned state forming loops, while staying nominally parallel to the tension axis. The portions of the transverse beams 1630 that undulate includes a portion of the cross-slits including a portion of the cross-slit terminal ends. The axial beam 1620 between adjacent slits 1610 in a row 1612 stays substantially parallel to the original plane of material 1600 in its pretensioned state. Overlap beams 1636 buckle and rotate out of the plane of the original material or sheet. The motion of the flap region 1650 in combination with the undulation of the transverse beams 1630 creates open portions 1622. This deployment process is substantially similar to the process described with respect to FIGS. 5A-C of application U.S. Provisional Patent Application No. 62/952,806, which is incorporated herein in its entirety.

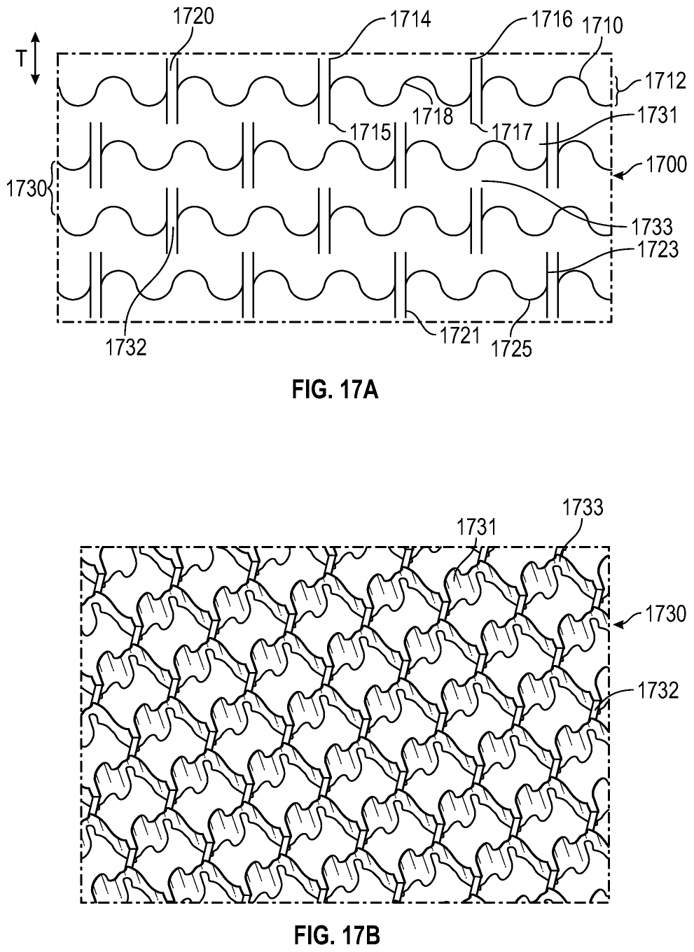

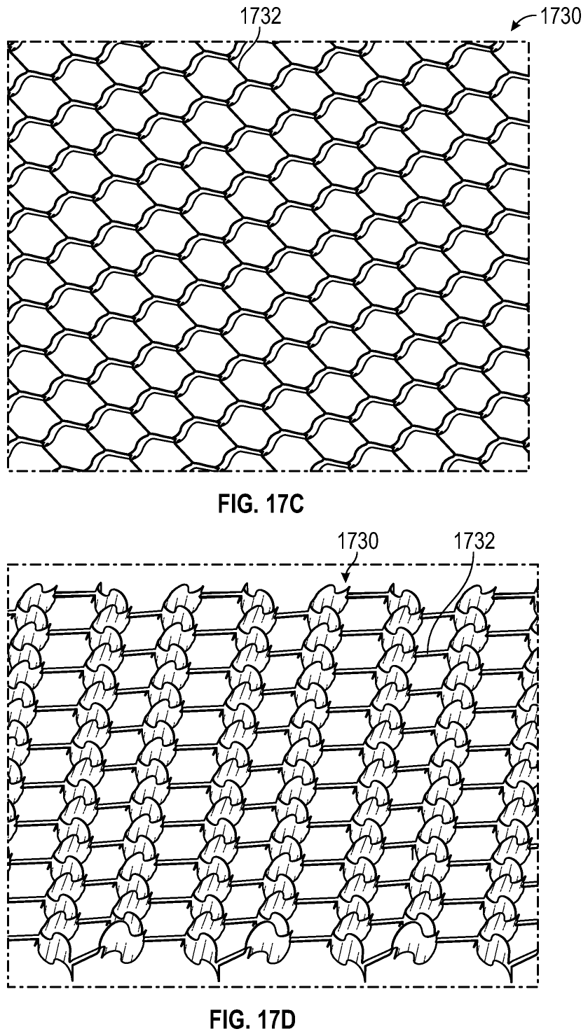

FIG. 17A is a top view schematic drawing of another exemplary compound slit pattern that is substantially similar to the compound slit pattern of FIG. 3A except that the generally transverse slit portion 1725 has a wavy form or structure. Such a slit pattern creates large and small wall sections (the accordion wall will have tall and short sections).

The tension axis (T) is substantially parallel to the axial direction and substantially perpendicular to the transverse direction and to the direction of the rows 1712 of slits 1710. The tension axis (T) is an axis along which tension can be provided to deploy the material into which the pattern 1700 has been formed, which creates the rotation and upward and downward movement of portions of the material.

FIGS. 17B-17D are drawings from photographs showing the compound slit pattern of FIG. 17A formed or cut into a material and then exposed to tension along tension axis T. The material deploys substantially as described above with respect to FIGS. 3A-4I. When multiple layers of the material are in contact, such as when wrapped around an object, then the varying heights of the rotating/folding wall 1730 can allow the layers to interlock with each other more strongly and in different ways.

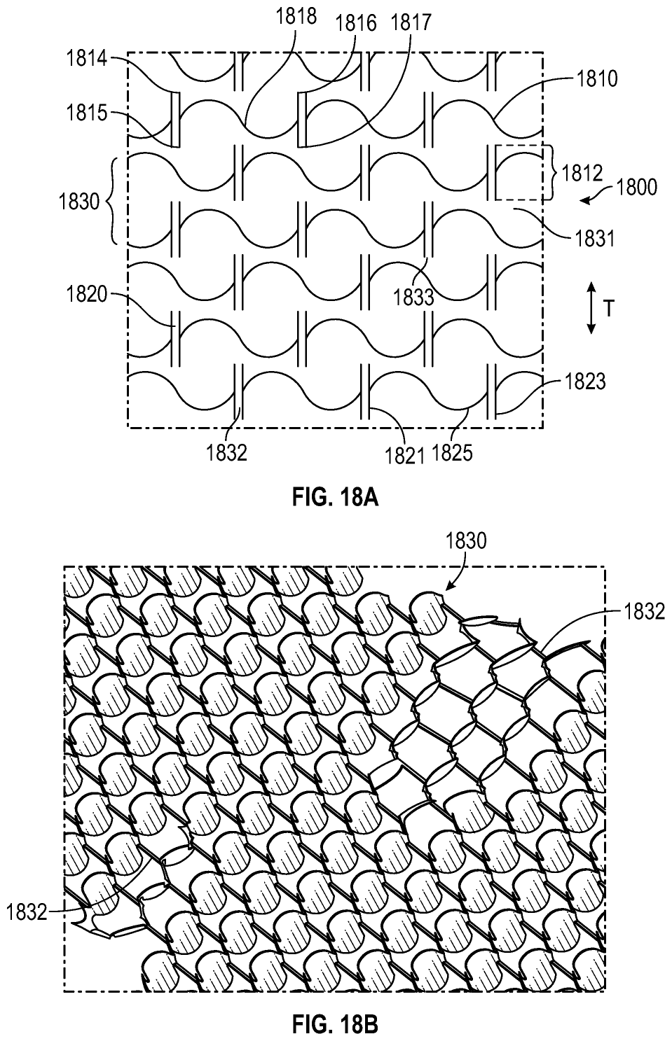

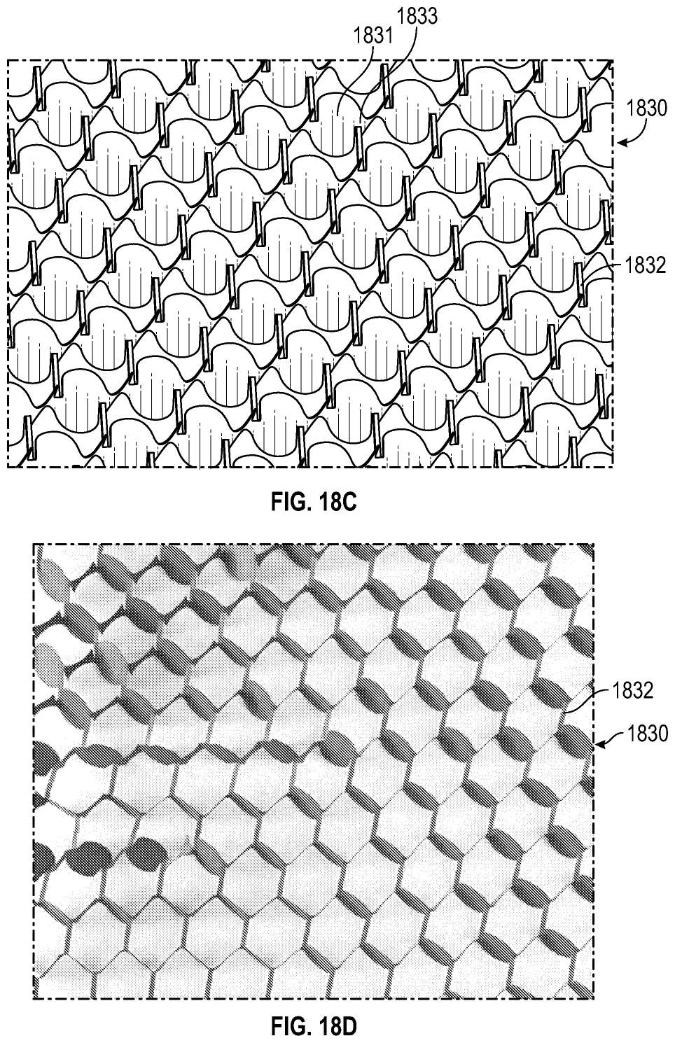

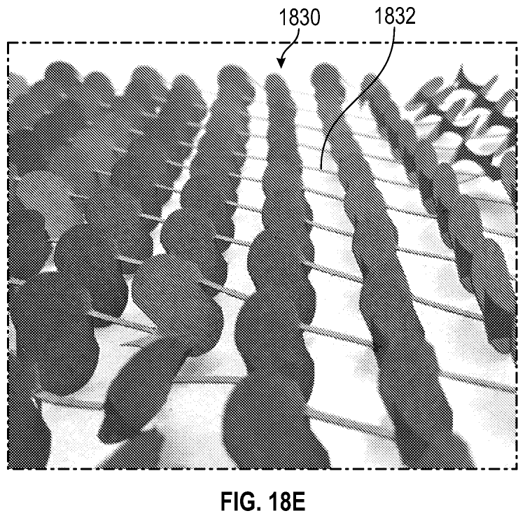

FIG. 18A is a top view schematic drawing of another exemplary compound slit pattern that is substantially similar to the compound slit pattern of FIG. 17A except that the oscillation of the wave in the transverse slit portion 1725 varies.

FIGS. 18B-18E are photographs and drawings from photographs showing the compound slit pattern of FIG. 18A formed or cut into a material and then exposed to tension along tension axis T. The material deploys substantially as described above with respect to FIGS. 17A-17D and 3A-4I.

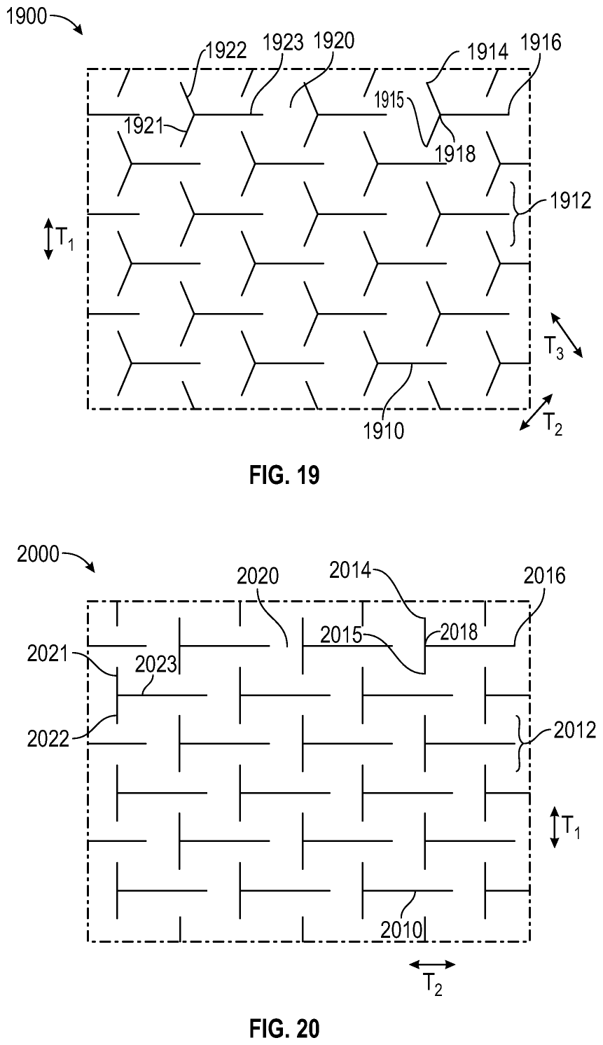

FIG. 19 is a top view schematic drawing of another exemplary compound slit pattern. The pattern 1900 includes a plurality of slits 1910 in rows of slits 1912. The slits 1910 have three terminal ends 1914, 1915,1916 that are on the end of three straight portions 1921, 1922, 1923. All of the straight portions 1921,1922, 1923 intersect at point 1918. The space between directly adjacent slits 1910 in a row 1912 forms an axial beam 1920 between adjacent slits 1910 in a row 1912. Directly adjacent rows of slits 1910 are phase offset from one another.

The unique geometry of the slits 1910 allows the material to respond to more than one tension axis. Specifically, it can expand when tension is applied substantially perpendicular to any of the three straight portions, represented by three primary tension axes (T1, T2, T3). The primary tension axes (T1, T2, T3) are the primary axes along which tension can be provided to deploy the material into which the pattern 1900 has been formed, which creates the rotation and upward and downward movement of portions of the material. Because the primary axes have components in all planar angles, tension in any direction will elicit some deployment of the material.

FIG. 20 is a top view schematic drawing of another exemplary compound slit pattern that is similar to the pattern shown in FIG. 19. The pattern 2000 includes a plurality of slits 2010 in rows of slits 2012. The slits 2010 have three terminal ends 2014, 2015, 2016 that are on the end of three straight portions 2021, 2022, 2023. Straight portions 2021 and 2022 are colinear. All of the straight portions 2021, 2022, 2023 intersect at point 2018. The space between directly adjacent slits 2010 in a row 2012 forms an axial beam 2020 between adjacent slits 2010 in a row 2012. Directly adjacent rows of slits 2010 are phase offset from one another.

The unique geometry of the slits 2010 allows the material to respond to more than one tension axis. Specifically, it can expand when tension is applied substantially perpendicular to any of the two straight portions, represented by two tension axes (T1, T2). The tension axes (T1, T2) are primary tension axes. Because the primary tension axes are orthogonal, tension in any axis will cause some deployment of the material into which the pattern 2000 has been formed, which creates the rotation and upward and downward movement of portions of the material.

Any of the embodiments shown or described herein can be combined with other embodiments shown or described herein, including that any specific features, shapes, structures, or concepts shown or described herein can be combined with any of the other specific features, shapes, structures, or concepts shown or described herein. Those of skill in the art will appreciate that many changes may be made to the compound slit patterns, formation of the patterns into materials, and deployment of those materials while still falling within the scope of the present disclosure. For example, in embodiments showing a double slit pattern, the pattern could be a triple slit, quadruple slit, or other multi-slit pattern instead of a double slit pattern. Alternatively, the slit length, slit size, slit thickness, slit shape, row size or shape, transverse beam size or shape, and/or overlap beam size or shape can vary. Further, the degrees of offset or phase offset can vary from what is shown. The slit, row, or beam pitch can vary. The angle between the tension axis and slits can vary. The alignment of the pattern relative to the tension axis and/or sides of the material may vary. Some of these changes could change the deployment pattern.

Most of the slit patterns shown herein have regions that are described as moving or buckling either upward or downward relative to the original plane of the sheet when tension is applied. The distinction between upward and downward motion is an arbitrary description used for clarity to substantially match the accompanying figures. The samples could all be flipped over turning the downward motions into upward motions and vice versa. In addition, it is normal and expected for occasional inversions to occur where the regions of the sample will flip such that similar features which had moved upward in previous regions are now moving downward and vice versa. These inversions can occur for regions as small as a single slit, or large portions of the material. These inversions are random and natural, they are a result of natural variations in materials, manufacturing, and applied forces. Although some effort was made to photograph regions of material without inversions, all samples were tested with the presence of these natural variations and performance is not significantly affected by the number or location of inversions.

All of the slit patterns shown herein are shown as being generally perpendicular to the tension axis. While in many embodiments this can provide superior performance, any of the slit patterns shown or described herein can be rotated at an angle to the tension axis. Angles less than 45 degrees from the tension axis are preferred.

Further, all of the slit patterns shown herein include slits that are out of phase with one another by approximately one half of the transverse spacing between directly adjacent slits (or 50% of the transverse spacing). However, the patterns may be out of phase by any desired amount including for example, one third of the transverse spacing, one quarter of the transverse spacing, one sixth of the transverse spacing, one eighth of the transverse spacing, etc. In some embodiments, the phase offset is less than 1 or less than three fourths, or less than one half of the transverse spacing of directly adjacent slits in a row. In some embodiments, the phase offset is more than one fiftieth, or more than one twentieth, or more than one tenth of the transverse spacing of directly adjacent slits in a row.

In some embodiments, the minimum phase offset is such that the terminal ends of slits in alternate rows intersect a line parallel to the tension axis through the terminal ends of slits in the adjacent rows. In some embodiments, the maximum phase offset is similarly limited by the creation of a continuous path of material. If the width of the slits orthogonal to the tension axis are constant for all slits and have a value w and the gap between slits orthogonal to the tension axis are constant and have a value g, then the minimum and maximum phase offsets are:

$$minimum phase offset = \frac{g}{w + g} , maximum phase offset = \frac{w}{w + g}$$

Articles. The present disclosure also relates to one or more articles or materials including any of the slit patterns described herein. Some exemplary materials into which the slit patterns described herein can be formed include, for example, paper (including cardboard, corrugated paper, coated or uncoated paper, kraft paper, cotton bond, recycled paper); plastic; woven and non-woven materials and/or fabrics; elastic materials (including rubber such as natural rubber, synthetic rubber, nitrile rubber, silicone rubber, urethane rubbers, chloroprene rubber, Ethylene Vinyl Acetate or EVA rubber); inelastic materials (including polyethylene and polycarbonate); polyesters; acrylics; and polysulfones. The article can be, for example, a material, sheet, film, or any similar construction.

Examples of thermoplastic materials that can be used include one or more of polyolefins (e.g., polyethylene (high density polyethylene (HDPE), medium density polyethylene (MDPE), low density polyethylene (LDPE), linear low density polyethylene (LLDPE)), metallocene polyethylene, and the like, and combinations thereof), polypropylene (e.g., atactic and syndiotactic polypropylene)), polyamides (e.g. nylon), polyurethane, polyacetal (such as Delrin), polyacrylates, and polyesters (such as polyethylene terephthalate (PET), polyethylene terephthalate glycol (PETG), and aliphatic polyesters such as polylactic acid), fluoroplastics (such as THV from 3M company, St. Paul, Minn.), and combinations thereof. Examples of thermoset materials can include one or more of polyurethanes, silicones, epoxies, melamine, phenol-formaldehyde resin, and combinations thereof. Examples of biodegradable polymers can include one or more of polylactic acid (PLA), polyglycolic acid (PGA), poly(caprolactone), copolymers of lactide and glycolide, poly(ethylene succinate), polyhydroxybutyrate, and combinations thereof.

“Paper” as used herein refers to woven or non-woven sheet-shaped products or fabrics (which may be folded, and may be of various thicknesses) made from cellulose (particularly fibers of cellulose, (whether naturally or artificially derived)) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper may have coatings on the sheet or on the fibers themselves. Examples of non-traditional products that are “paper” within the context of this disclosure include the material available under the trade designation TRINGA from PAPTIC (Espoo, Finland), and sheet forms of the material available under the trade designation SULAPAC from SULAPAC (Helsinki, Finland)

The material in which the single slit pattern is formed can be of any desired thickness. In some embodiments, the material has a thickness between about 0.001 inch (0.025 mm) and about 5 inches (127 mm). In some embodiments, the material has a thickness between about 0.01 inch (0.25 mm) and about 2 inches (51 mm). In some embodiments, the material has a thickness between about 0.1 inch (2.5 mm) and about 1 inch (25.4 mm). In some embodiments, the thickness is greater than 0.001 inch (0.025 mm), or 0.01 inch (0.25 mm), or 0.05 inch (1.3 mm), or 0.1 inch (2.5 mm), or 0.5 inch (13 mm), or 1 inch (25 mm), or 1.5 inches (38 mm), or 2 inches (51 mm), or 2.5 inches (64 mm), or 3 inches (76 mm). In some embodiments, the thickness is less than 5 inches (127 mm) or 4 inches (101 mm), or 3 inches (76 mm), or 2 inches (51 mm), or 1 inch (25 mm), or 0.5 inch (13 mm), or 0.25 inch (6.3 mm), or 0.1 inch (2.5 mm).

In some embodiments, where the material is paper, the thickness is between about 0.003 inch (0.076 mm) and about 0.010 inch (0.25 mm). In some embodiments where the material is plastic, the thickness is between about 0.005 inch (0.13 mm) and about 0.125 inch (3.2 mm).

In some embodiments, the slit or cut pattern extends substantially to one or more of the edges of the sheet, film, or material. In some embodiments, this allows the material to be of unlimited length and also to be deployed by tension, particularly when made with non-extensible materials. A “non-extensible” material is generally defined as a material that when in a cohesive, unadulterated configuration (absent slits) has an ultimate elongation value of under 25%, less than or equal to 10% or, in some embodiments, less than or equal to 5%. The amount of edge material is the area of material surrounding and not including the single slit pattern. In some embodiments, the amount of edge material, or down-web border, can be defined as the width of the rectangle whose long axis is parallel to the tension axis and is infinitely long and can be drawn on the substrate without overlapping or touching any slits. In some embodiments, the amount of edge material is less than 0.010 inch (0.25 mm) or less than 0.001 inch (0.025 mm). In some embodiments, the width of the down-web border is less than 0.010 inch (0.25 mm) or less than 0.001 inch (0.025 mm). In some embodiments, the amount of edge material is less than 5 times the thickness of the substrate. In some embodiments, the width of the down-web border is less than 5 times the thickness of the substrate.

Cross-web slabs can be defined as rectangular regions with a rectangle whose long axis is perpendicular to the tension axis and is infinitely long and whose width is some finite number and can be drawn on the substrate without overlapping or touching any slits or cuts. In some embodiments, cross-web slabs of any width may already exist within the article as an integral part of the pattern. In some embodiments, cross-web slabs of any width may be added to the ends of a finite length article to make the article easier to deploy. In some embodiments, cross-web slabs of any width may be added intermittently to a continuously patterned article.

In some embodiments, the distance between the farthest spaced terminal ends of a single slit (also referred to as the slit length) is between about 0.25 inch (0.001 mm) long and about 3 inches (76 mm) long, or between about 0.5 inch (13 mm) and about 2 inches (51 mm), or between about 1 inch (25 mm) and about 1.5 inches (38 mm). In some embodiments, the farthest distance between terminal ends of a single slit (also referred to as slit length) is between 50 times the substrate thickness and 1000 times the substrate thickness, or between 100 and 500 times the substrate thickness. In some embodiments, the slit length is less than 1000 times the substrate thickness, or less than 900 times, or less than 800 times, or less than 700 times, or less than 600 times, or less than 500 times, or less than 400 times, or less than 300 times, or less than 200 times, or less than 100 times the substrate thickness. In some embodiments, the slit length is greater than 50 times the substrate thickness, or greater than 100 times, or greater than 200 times, or greater than 300 times, or greater than 400 times, or greater than 500 times, or greater than 600 times, or greater than 700 times, or greater than 800 times, or greater than 900 times the substrate thickness.

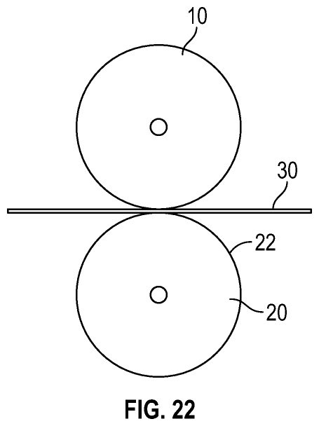

Method of Making. The slit patterns and articles described herein can be made in a number of different ways. For example, the slit patterns can be formed by extrusion, molding, laser cutting, water jetting, machining, stereolithography or other 3D printing techniques, laser ablation, photolithography, chemical etching, rotary die cutting, stamping, other suitable negative or positive processing techniques, or combinations thereof. In particular, with reference to FIG. 22, paper or another sheet material 30 can be fed into a nip consisting of a rotary die 20 and an anvil 10. In this example the material 30 is stored in a roll configuration where the material is rolled around a central axis that may include or may omit a central core. The rotary die 20 has cutting surfaces 22 on it that correspond to the pattern desired to be cut into the sheet material 30. The die 20 cuts through the material 30 in desired places and forms the slit pattern described herein. The same process can be used with a flat die and flat anvil.

Method of Using. The articles and materials described herein can be used in various ways. In one embodiment, the two dimensional sheet, material, or article has tension applied along the tension axis, which causes the slits to form the openings and/or flaps and/or motions described herein. In some embodiments, the tension is applied by hand or with a machine.

Uses. The present disclosure describes articles that begin as a flat sheet but deploy into a three-dimensional construction upon the application of force/tension. In some embodiments, such constructions form energy absorbing structures. The patterns, articles, and constructions described herein have a large number of potential uses, at least some of which are described herein.

One exemplary use is to protect objects for shipping or storage. As stated above, existing shipping materials have a variety of drawbacks including, for example, they occupy too much space when stored before use (e.g., bubble wrap, packing peanuts) and thus increase the cost of shipping; they require special equipment to manufacture (e.g., inflatable air bags); they are not always effective (e.g., crumpled paper); and/or they are not widely recyclable (e.g., bubble wrap, packing peanuts, inflatable air bags). The tension-activated, expanding films, sheets, and articles described herein can be used to protect items during shipping without any of the above drawbacks. When made of sustainable materials, the articles described herein are effective and sustainable. Because the articles described herein are flat when manufactured, shipped, sold, and stored and only become three-dimensional when activated with tension/force by the user, these articles are more effective and efficient at making the best use of storage space and minimizing shipping/transit/packaging costs. Retailers and users can use relatively little space to house a product that will expand to 10 or 20 or 30 or 40 or more times its original size. Further, the articles described herein are simple and highly intuitive for use. The user merely pulls the product off the roll or takes flat sheets of product, applies tension across the article along the tension axis (which can be done by hand or with a machine), and then wraps the product around an item to be shipped. In many embodiments, no tape is needed because the interlocking features enable the product to interlock with another layer of itself.

In some embodiments, the slit patterns described herein create packaging materials and/or cushioning films that provide advantages over the existing offerings. For example, in some embodiments, the packaging materials and/or cushioning films of the present disclosure provide enhanced cushioning or product protection. In some embodiments, the packaging materials and/or cushioning films of the present disclosure provide similar or enhanced cushioning or product protection when compared to the existing offerings but are recyclable and/or more sustainable or environmentally friendly than existing offerings. In some embodiments, the packaging materials and/or cushioning films of the present disclosure provide similar or enhanced cushioning or product protection when compared to the existing offerings but can be expanded and wrapped around an item to be shipped. Constructions that hold their shape once tension is applied can be preferred because they may eliminate the need for tape to hold the material in place for many applications.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described embodiments (or one or more aspects thereof) may be used in combination with each other. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention can be determined with reference to the appended claims, along with the full scope of equivalents to which such claims are entitled.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Those having skill in the art will appreciate that many changes may be made to the details of the above-described embodiments and implementations without departing from the underlying principles thereof. Further, various modifications and alterations of the present disclosure will become apparent to those skilled in the art without departing from the spirit and scope of the disclosure. The scope of the present application should, therefore, be determined only by the following claims and equivalents thereof.

1. An expanding material, comprising:
a sheet of material having a plurality of slits arranged in a plurality of rows of slits, wherein each of the slits in a row are spaced in a transverse direction from directly adjacent slits in the row to form an axial beam, wherein the axial beam extends between slits in adjacent rows, wherein the plurality of slits include a repeating pattern of compound slits each having more than two terminal ends, and wherein the material has an ultimate elongation value of under 25% when in a configuration absent slits.

2. The expanding material of claim 1, wherein the material defines a plane in a pretensioned form and defines a tension axis, and wherein at least portions of the material rotate 45 degrees or greater from the plane when tension is applied along the tension axis.

3.-4. (canceled)

5. The expanding material of claim 1, wherein the plurality of compound slits define a slit pattern extending through one or more of the edges of the material.

6. The expanding material of claim 1, wherein the material includes at least one of paper, corrugated paper, plastic, an elastic material, an inelastic material, polyester, acrylic, polysulfone, thermoset, thermoplastic, biodegradable polymers, a woven material, a non-woven material, and combinations thereof.

7. The expanding material of claim 1, wherein the material is paper having a thickness of about 0.003 inch (0.076 mm) to about 0.010 inch (0.25 mm).

8. The expanding material of claim 1, wherein the material is plastic having a thickness of about 0.005 inch (0.13 mm) to about 0.125 inch (3.2 mm).

9. (canceled)

10. The expanding material of claim 1, wherein each of the slits have a transverse length that is perpendicular to the tension axis.

11. The expanding material of claim 1, wherein each slit has a transverse length and the slits in a first row of slits are offset from slits in an adjacent row of slits by 75% or less of the transverse length of each slit in the first rows of slits.

12. (canceled)

13. The expanding material of claim 1, wherein the slits have a slit shape and slit orientation and wherein the slit shape, slit orientation, or both slit shape and slit orientation varies in adjacent rows.

14. The expanding material of claim 1, wherein the material has a thickness of about 0.001 inch (0.025 mm) to about 5 inches (127 mm).

15. (canceled)

16. The expanding material claim 1, wherein each slit in the plurality of slits has a slit length and the material has a material thickness, and wherein the ratio of slit length to material thickness is about 50 to about 1000.

17. A die capable of forming the plurality of slits of claim 1.

18. A packaging material comprising the expanding materials claim 1.

19. The packaging material of claim 18, wherein the expanding material is in a roll configuration.

20. The packaging material of claim 18, wherein the expanding material is one or more individual sheets.

21. The packaging material of claim 20, further comprising an envelope having the expanding material disposed in the envelope.

22. A method of making the expanding material of claim 1, comprising:
forming the plurality of slits in the material by at least one of by extrusion, molding, laser cutting, water jetting, machining, stereolithography, laser ablation, photolithography, chemical etching, rotary die cutting, stamping, or combinations thereof.

23. A method of using the expanding material of claim 1, comprising:
applying tension to the expanding material along a tension axis to cause the material to expand.

24. (canceled)

25. The method of claim 23, wherein the tension is applied by hand or with a machine.

26. The method of claim 23, wherein applying tension to the expanding material along the tension axis causes the material to change from a two-dimensional structure to a three-dimensional structure.

27-28. (canceled)
